(19) United States
(12) Patent Application Publication
(10) Pub. No.: US 2015/0079439 A1
(43) Pub. Date: Mar. 19, 2015

(54) ACTIVE SUBSTANCE, NONAQUEOUS ELECTROLYTE BATTERY AND BATTERY PACK

(71) Applicant: KABUSHIKI KAISHA TOSHIBA, Minato-ku (JP)

(72) Inventors: Takuya IWASAKI, Uenohara (JP); Hiroki Inagaki, Yokohama (JP); Norio Takami, Yokohama (JP)

(73) Assignee: KABUSHIKI KAISHA TOSHIBA, Minato-ku (JP)

(21) Appl. No.: 14/488,529

(22) Filed: Sep. 17, 2014

(30) Foreign Application Priority Data
Sep. 17, 2013 (JP) 2013-192250
Aug. 29, 2014 (JP) 2014-176423

(51) Int. Cl. H01M 4/36; H01M 10/0525; H01M 4/131; H01M 4/48; H01M 4/62; H01M 10/42

(52) U.S. Cl. CPC H01M 4/364; H01M 4/622; H01M 10/4257; H01M 4/623; H01M 4/366; H01M 4/131; H01M 4/483; H01M 10/0525; H01M 2010/4271
USPC 429/90; 429/217

(57) ABSTRACT

According to one embodiment, there is provided an active substance. The active substance includes a plurality of composites and a binding phase positioned between the composites. The composite includes an active material particle and a coating layer coating the active material particles. The coating layer includes at least one selected from the group consisting of hydroxyalkyl cellulose and carboxymethyl cellulose. The binding phase includes at least one selected from the group consisting of polyvinylidene fluoride, styrene-butadiene rubber, and an acrylic-based polymer.

### CROSS-REFERENCE TO RELATED APPLICATIONS

This application is based upon and claims the benefit of priority from the Japanese Patent Applications No. 2013-192250, filed Sep. 17, 2013: and No. 2014-176423, filed Aug. 29, 2014, the entire contents of all of which are incorporated herein by reference.

### FIELD

Embodiments described herein relate generally to an active substance, an electrode, a nonaqueous electrolyte battery and a battery pack.

### BACKGROUND

Much attention is focused on a nonaqueous electrolyte battery as a power source for hybrid vehicles and electric vehicles or the like. The required characteristics of nonaqueous electrolyte batteries used in such applications are a large capacity, a long life, and good input-and-output performances.

Generally, a carbon-based material has been used as a negative electrode active material for a nonaqueous electrolyte battery. Recently, lithium titanate having a spinel structure has also been used. The volume of lithium titanate having a spinel structure is not changed with a charge and discharge reactions. Therefore, the lithium titanate has excellent cycle performance. Furthermore, the lithium titanate has high safety because it has a low possibility of occurrence of lithium dendrites as compared with the case of using a carbon-based material. Because lithium titanate having a spinel structure is a ceramic, thermal runaway of the battery is unlikely to occur.

On the other hand, a monoclinic β-type titanium composite oxide has attracted much attention as a negative electrode active material in recent years. The monoclinic β-type titanium composite oxide has the advantage that it has a high capacity.

It is desired to further improve the life performance of the nonaqueous electrolyte battery using the material mentioned above.

### BRIEF DESCRIPTION OF THE DRAWINGS

FIG. 1 is a schematic sectional view of an active substance of an example according to a first embodiment;

FIG. 2 is a schematic sectional view of an electrode of an example according to a second embodiment;

FIG. 3 is a schematic sectional view of a nonaqueous electrolyte battery of a first example according to a third embodiment;

FIG. 4 is an enlarged sectional view of a part A of the nonaqueous electrolyte battery shown in FIG. 3;

FIG. 5 is a partially broken schematic perspective view of a nonaqueous electrolyte battery of a second example according to the third embodiment;

FIG. 6 is an enlarged sectional view of a part B of the nonaqueous electrolyte battery shown in FIG. 5;

FIG. 7 is a schematic development perspective view of a nonaqueous electrolyte battery of a third example according to the third embodiment;

FIG. 8 is a schematic exploded perspective view of a battery pack of an example according to a fourth embodiment;

FIG. 9 is a block diagram showing an electric circuit of the battery pack shown in FIG. 8;

FIG. 10 is a block diagram showing an electric circuit of a battery pack of another example according to a fourth embodiment; and

FIG. 11 is a schematic sectional view of a battery active substance of comparative examples 1-3.

### DETAILED DESCRIPTION

In general, according to one embodiment, there is provided an active substance. The active substance includes a plurality of composites and a binding phase positioned between the composites. The composite includes an active material particle and a coating layer coating the active material particles. The coating layer includes at least one material selected from the group consisting of hydroxyalkyl cellulose and carboxymethyl cellulose. The binding phase includes at least one selected from the group consisting of polyvinylidene fluoride, styrene-butadiene rubber, and an acrylic-based polymer.

Hereinafter, the embodiment will be described with reference to the drawings. In the following description, structural elements exhibiting the same or similar function throughout all the drawings are designated by the same reference signs and repeated explanations are omitted.

### First Embodiment

According to a first embodiment, there is provided an active substance. The battery active substance includes a plurality of composites and a binding phase positioned between the composites. The composite includes an active material particles and a coating layer coating the active material particles. The coating layer includes at least one material selected from the group consisting of hydroxyalkyl cellulose and carboxymethyl cellulose (CMC). The binding phase includes at least one selected from the group consisting of polyvinylidene fluoride, styrene-butadiene rubber, and an acrylic-based polymer.

The at least one material selected from the group consisting of hydroxyalkyl cellulose and carboxymethyl cellulose included in the coating layer has small volumetric shrinkage after drying. Therefore, the composite includes the coating layer which can exhibit excellent coatability even after drying. Furthermore, the coating layer exhibiting excellent coatability can maintain a high surface coating ratio even if the volumes of the active material particle are changed. And then, the at least one material selected from the group consisting of hydroxyalkyl cellulose and carboxymethyl cellulose included in the coating layer can hold a nonaqueous electrolyte. Therefore, the coating layer can hold the nonaqueous electrolyte, and can provide and maintain an ion transmission path between the nonaqueous electrolyte and the active material particle.

On the other hand, the binding phase has poor nonaqueous electrolyte retainability and lithium ion conductivity. However, because the binding phase is not substantially brought into contact with the active material particle in the active substance according to the first embodiment, the binding phase does not hinder the transmission of ions between the nonaqueous electrolyte and the active material particle.

Furthermore, because, as described above, the coating layer having excellent coatability can coat the active material particle, and maintain the state of the surface coating, the coating layer can suppress the reaction between the active material particle and the nonaqueous electrolyte and the reaction between the active material particle and the binding phase. Thus, this coating layer can suppress the eventual generation of a byproduct which may be generated in these reactions. This byproduct may cause deterioration of the electrode performance and an increase in internal resistance of a battery.

On the other hand, the coating layer is swollen by the held nonaqueous electrolyte, which may cut the ion conduction path to the active material particle. The breakage of the ion conduction path to the active material particle may cause an increase in the resistance of a nonaqueous electrolyte battery using the active material particle.

The inventors found that the swelling of the coating layer caused by holding the nonaqueous electrolyte could be suppressed by positioning the binding phase between the plurality of composites including the active material particle and the coating layer. A clear mechanism capable of suppressing the swelling of the coating layer due to the existence of the binding phase is not found. However, it is assumed that the high binding ability of the binding phase contributes to the effect.

Thus, when the active substance according to the first embodiment is used in the nonaqueous electrolyte battery, the coating layer can provide a transmission path for lithium ions, and the hindrance of the transmission of lithium ions caused by the binding phase can be prevented. Therefore, the active substance according to the first embodiment can suppress the breakage of the ion transmission path. As a result, the active substance according to the first embodiment can prevent an increase in resistance caused by the breakage of the ion transmission path when the active substance is used in the nonaqueous electrolyte battery. Furthermore, when the active substance according to the first embodiment is used in the nonaqueous electrolyte battery, the coating layer can suppress the reaction between the active material particle and the nonaqueous electrolyte and the reaction between the active material particle and the binding phase. This can suppress the deterioration of the electrode performance and the increase in the internal resistance of the battery which are caused by the byproduct which may be generated in these reactions, and can also suppress the problem of the deterioration of the nonaqueous electrolyte. Due to this, the battery substance according to the first embodiment can realize a nonaqueous electrolyte battery which can exhibit a high capacity retention after a cycle, and can suppress an increase in a resistance value through a cycle.

Further, because the binding phase has high binding ability in the active substance according to the first embodiment, the binding phase can also bind the a plurality of composites. As described earlier, in the active substance according to the first embodiment, the coating layer can suppress the reaction between the binding phase and the active material particles. The eventual decomposition of the binding phase can therefore be suppressed. Therefore, the nonaqueous electrolyte battery including the active substance according to the first embodiment in which the binding phase binds the plurality of composites can maintain the binding between the composites even if charging and discharging is frequently repeated. As a result, the nonaqueous electrolyte battery can exhibit a higher capacity retention after a cycle, and can further suppress an increase in a resistance value through a cycle.

Furthermore, when the active substance according to the first embodiment is used in the electrode, the binding phase can also perform a role of binding the composites to, for example, a current collector. As described earlier, in the active substance according to the first embodiment, the coating layer can suppress the reaction between the binding phase and the active material particles, and can suppress the decomposition of the binding phase. Therefore, the active substance according to the first embodiment in which the binding phase binds the plurality of composites to the current collector can prevent the decrease of the adhesive property of the active substance layer including the composites to the current collector even if charging and discharging is frequently repeated. Thus, the use of the active substance according to the first embodiment can provide an electrode having excellent strength, and can maintain an effect of suppressing the swelling of the coating layer of the binding phase. Thereby, there can be provided a nonaqueous electrolyte battery which can prevent the increase in the resistance caused by the deterioration of the ion conduction path or the like.

For example, a transmission electron microscope (TEM) or a scanning electron microscope (SEM) can confirm that the active material particle is coated with the coating layer including at least one material selected from the group of hydroxyalkyl cellulose and carboxymethyl cellulose, and the binding phase is positioned between the plurality of composites each of which includes the active material particle and the coating layer. For example, a time-of-flight secondary ion mass spectroscopy meter (TOF-SIMS) can confirm that the binding phase binds the plurality of composites.

Hydroxyalkyl cellulose and carboxymethyl cellulose are soluble in an organic solvent, e.g., N-methylpyrrolidone. Hydroxyalkyl cellulose or carboxymethyl cellulose has high affinity for the surface of the active material particle. Therefore, when the active material particle and hydroxyalkyl cellulose or carboxymethyl cellulose are added to N-methylpyrrolidone, and these are stirred, followed by drying, hydroxyalkyl cellulose or carboxymethyl cellulose is bound to the surface of the active material particle. As a result, composites each of which includes the active material particles and the coating layer coating the active material particles can be obtained.

Next, the active substance according to the first embodiment will be described in detail.

As described earlier, the active substance according to the first embodiment includes the composites. Each of the composites includes the active material particle and the coating layer coating the active material particle.

The active material particle can include a compound into which lithium ions can be absorbed at a potential of 0.4 V or more relative to lithium metal, for example. The use of such a compound can suppress the precipitation of lithium metal on the surface of the electrode including the active substance according to the first embodiment. Due to this, internal short circuits developed when the nonaqueous electrolyte battery including the active substance of the first embodiment is charged and discharged at a large current can be prevented.

Examples of such a compound include a metal oxide, a metal sulfide, a metal nitride, and an alloy. Hereinafter, the potential relative to lithium metal is referred to in “V (vs. Li/Li⁺)”. As the compound included in the active material particle, compounds in which absorption of lithium ion occurs at a potential of 3 V (vs. Li/Li⁺) or less, and preferably 2 V (vs. Li/Li⁺) or less are preferably used.

Examples of the metal oxide include a titanium-including metal composite oxide, a niobium composite oxide, a tin-based oxide such as SnB_{0.4}P_{0.6}O_{3.1} or SnSiO₃, a silicon-based oxide such as SiO, and a tungsten-based oxide such as WO₃. Among these, the titanium-including metal composite oxide and the niobium composite oxide are preferable.

Examples of the titanium-including metal composite oxide include a lithium-titanium oxide, a titanium-based oxide, and a lithium-titanium composite oxide in which a part of the structural elements thereof are substituted with heteroatoms. In the titanium-based oxide, a part of lithium ions absorbed in the charge and discharge reaction of the nonaqueous electrolyte battery including the active substance according to the first embodiment remain. Thereby, the titanium-based oxide is changed to a titanium-based oxide containing lithium.

Examples of the lithium-titanium oxide include lithium titanate having a spinel structure (for example, Li₄₊ₓTi₅O₁₂) and lithium titanate having a rhamsdelite structure (for example, Li_{2+y}Ti₃O₇). In the above formula, x and y vary when a battery is charged or discharged, and satisfy the relationship represented by the inequality of −1≦x≦3 and −1≦y≦3, respectively.

Examples of the titanium-based oxide include TiO₂, a monoclinic β-type titanium composite oxide, and a metal composite oxide containing Ti and at least one element selected from the group consisting of V, Sn, Cu, Ni, Co, and Fe. Among these, the monoclinic β-type titanium composite oxide is suitably used.

Examples of TiO₂ include a titanium composite oxide (α-TiO₂ and γ-TiO₂) having an anatase type or rutile type structure.

The monoclinic β-type titanium composite oxide means a titanium composite oxide having the crystal structure of monoclinic titanium dioxide. The crystal structure of monoclinic titanium dioxide belongs primarily to the space group C2/m. Hereinafter, the monoclinic β-type titanium composite oxide is referred to as “TiO₂(B)”. TiO₂(B) includes those oxides in which a part of their structural elements is substituted with a heteroatom such as Li.

Examples of the metal composite oxide containing Ti and at least one element selected from the group consisting of V, Sn, Cu, Ni, Co, and Fe include TiO₂—V₂O₅, TiO₂—P₂O₅—SnO₂, and TiO₂—P₂O₅—MeO (herein, Me is at least one element selected from the group consisting of Cu, Ni, Co, and Fe). This metal composite oxide preferably has a structure where a crystal phase and an amorphous phase coexist or a structure where an amorphous phase singly exists. The active substance according to the first embodiment including the active material particle including the metal composite oxide having such a microstructure can attain a nonaqueous electrolyte battery having remarkably improved cycle performance.

Examples of the niobium titanium composite oxide include LiₓNbₐTi_{b}O_{c} (0≦x≦3, 0<a≦3, 0<b≦3, 5<c≦10). Examples of LiₓNbₐTi_{b}O_{c} include LiₓNb₂TiO₇, LiₓNb₂Ti₂O₉, and LiₓNbTiO₅. LiₓTi_{1-y}Nb_{y}Nb₂O_{7+σ} (0≦x≦3, 0≦y≦1, 0≦σ≦0.3) heat-treated at 800° C. to 1200° C. has a high true density, and can increase a volume specific capacity.

LiₓNb₂TiO₇ has a high density and a high capacity, which is preferable. Thereby, the capacity of the negative electrode can be increased. A part of Nb or Ti in the above oxides may be substituted with at least one element selected from the group consisting of V, Zr, Ta, Cr, Mo, W, Ca, Mg, Al, Fe, Si, B, P, K, and Na.

Examples of the metal sulfide include a titanium-based sulfide such as TiS₂, a molybdenum-based sulfide such as MoS₂, and an iron-based sulfide such as FeS, FeS₂, or LiₓFeS₂ (herein, 0≦x≦4).

Examples of the metal nitride include a lithium-based nitride such as (Li, Me)₃N (herein, Me is a transition metal element).

The active material particle can include other active materials, e.g., silicon, a silicon composite oxide, and graphite.

The active material particle may include either any one of the above compounds singly or two or more of the above compounds. The active material particle may further include other compounds.

The active material particle may have a form of a primary particle. Alternatively, the active material particle may have a form of a secondary particle which is constructed by aggregated primary particles. The active material particle is preferably in the form of secondary particle from the viewpoint of the stability of slurry used to produce an electrode. Because the secondary particle has a relatively smaller specific surface area, a side reaction with a nonaqueous electrolyte can be suppressed when the active substance in the battery is used.

Preferably, the active material particle includes at least one selected from the group consisting of lithium titanate having a spinel structure, TiO₂(B), silicon, a composite oxide of silicon and silicon dioxide, and graphite.

An active substance layer containing TiO₂(B), a composite oxide of silicon and silicon dioxide, and graphite or the like is largely changed in crystal lattice size during charging and discharging of a battery. When the volume of the active substance layer is largely changed, the distortion of the active substance layer and the peeling from the current collector are easily caused. The occurrence of the distortion and peeling leads to increased resistance. As a result, the cycle performance of a battery is deteriorated. In the battery including the active substance according to the first embodiment in which the active material particle include these compounds, the coating layer coating the active material particle maintains excellent coatability even if the volumes of the active material particles are changed. Therefore, the distortion and peeling of the active substance layer can be suppressed.

The lithium titanate having a spinel structure and TiO₂(B) exhibit solid acidity. The reason for this is considered to be that the solid acid points (for example, a hydroxyl group (OH⁻) and a hydroxyl group radical (OH.)) which has high reactivity are present on the surface of the compound. Such a compound has high reactivity with the nonaqueous electrolyte. Therefore, the solid acid points may decompose the nonaqueous electrolyte brought into contact with the solid acid points, to produce a byproduct. The accumulation of the byproduct thus produced may give rise to problems such as deterioration of electrode performance, breakage of a conductive path, and an increase in resistance. There is also a problem that the nonaqueous electrolyte is deteriorated when it is decomposed.

As described earlier, the coating layer including at least one material selected from the group consisting of hydroxyalkyl cellulose and carboxymethyl cellulose can have high affinity for the active material particle, and thereby the coating layer can exhibit excellent coatability. Particularly, hydroxyalkyl cellulose or carboxymethyl cellulose selectively coats the solid acid points of the lithium titanate having a spinel structure or of TiO₂(B), and thereby the solid acid points can be inactivated. Because hydroxyalkyl cellulose or carboxymethyl cellulose can coat the solid acid points of the lithium titanate having a spinel structure or TiO₂(B), the coating layer can reduce the reactivity between the lithium titanate having a spinel structure or TiO₂ (B) and the nonaqueous electrolyte. Due to this, the deterioration of the electrode performance, increase in the internal resistance of the battery, and deterioration of the nonaqueous electrolyte can be suppressed. Moreover, the coating layer can inactivate the solid acid points of the active material, and thereby the irreversible capacity of the battery can be reduced, and the efficiency of charge and discharge can also be improved. For these reasons, the battery active substance according to the first embodiment can attain a nonaqueous electrolyte battery which can exhibit improved cycle performance. The solid acid points of the lithium titanate having a spinel structure or TiO₂(B) are unnecessarily all coated, but it is only necessary to coat at least a part of these solid points.

The secondary particles of TiO₂(B) break easily when the density of an electrode is increased, and thereby the electric path between primary particles may be cut. When the electric path between primary particles is cut, the input and output performances of the battery are deteriorated. However, hydroxyalkyl cellulose having high coatability is used, and thereby the density of the electrode can be improved while keeping the shape of the secondary particles of TiO₂(B). This ensures that a close electric path can be formed between the primary particles and secondary particles of TiO₂(B). As a result, the feature of the high energy density of TiO₂(B) can be sufficiently utilized.

More specifically, the battery active substance according to the first embodiment in which the active material particle contains TiO₂(B) can attain a nonaqueous electrolyte battery which has a high energy density and excellent input and output performances.

As described earlier, the coating layer coating the active material particle contain at least one material selected from the group consisting of hydroxyalkyl cellulose and carboxymethyl cellulose.

Hydroxyalkyl cellulose may be soluble in an organic solvent. Examples thereof include hydroxypropyl methylcellulose, hydroxypropyl cellulose, hydroxyethyl cellulose, or hydroxypropylethyl cellulose. The coating layer can include a kind of hydroxyalkyl cellulose, or can include two or more kinds of hydroxyalkyl celluloses. The coating layer preferably includes hydroxypropyl methylcellulose.

The ratio of the total mass of at least one material selected from hydroxyalkyl cellulose and carboxymethyl cellulose in the battery active substance to the mass of the active material particle is preferably within a range of 0.01% by mass to 10% by mass. The battery active substance according to the first embodiment in which the total mass of the at least one material is within a range of 0.01% by mass to 10% by mass can be further improved in adhesive property, and can prevent the conductivity of an electrode which can be attained by the active substance from being impaired.

The coating layer can further include a conductive agent. The conductive agent can be included in the coating layer can include, for example, for the purpose of improving a current-collecting performance. The battery active substance in which the coating layer includes the conductive agent can also suppress the contact resistance with the current collector in the nonaqueous electrolyte attained by the active substance. Examples of the conductive agent include carbon-based materials such as cokes, carbon black, graphite, carbon nanofiber and carbon nanotubes. The average particle diameter of the carbon-based materials is preferably 0.1 μm to 10 μm. When the average particle diameter is 0.1 μm or more, the generation of gas can be efficiently suppressed. When a carbon-based material having an average particle diameter of 10 μm or less is used, a better conductive network is obtained in the active substance. The specific surface area of the carbon-based materials is preferably 10 m²/g to 100 m²/g. When a carbon-based material having a specific surface area of 10 m²/g or more is used, a better conductive network is obtained in the active substance. When a carbon-based material having a specific surface area of 100 m²/g or less is used, the generation of gas can be efficiently suppressed.

A binding phase is positioned between the composites each of which includes the active material particle and the coating layer coating the active material particle. The binding phase includes at least one selected from the group consisting of polyvinylidene fluoride (PVDF), styrene-butadiene rubber (SBR), and an acrylic-based polymer.

The acrylic-based polymer may be a homopolymer or a copolymer. Alternatively, the binding phase may include both the acrylic-based polymer as the homopolymer and the acrylic-based polymer as the copolymer. The binding phase can include a kind of acrylic-based polymer, or can include two or more kinds of acrylic-based polymers.

Examples of a monomer constituting the acrylic-based polymer include a monomer having an acryl group and a monomer having a methacryl group. The monomer having an acryl group is typically an acrylic acid or acrylate. The monomer having a methacryl group is typically a methacrylic acid or methacrylate.

Examples of the monomer constituting the acrylic-based polymer include ethyl acrylate, methyl acrylate, butyl acrylate, 2-ethylhexyl acrylate, isononyl acrylate, hydroxyethyl acrylate, methyl methacrylate, glycidyl methacrylate, acrylonitrile, acrylamide, styrene, and acrylamide.

In the battery active substance according to the first embodiment, the binding phase preferably includes both PVDF and the acrylic-based polymer. The battery active substance according to the first embodiment in which the binding phase includes both PVDF and the acrylic-based polymer can exhibit more excellent binding ability to the current collector and more excellent binding ability between the composites in the electrode attained by the active substance. As a result of such, an electrode having further improved strength can be attained.

The ratio of the mass of the binding phase included in the battery active substance according to the first embodiment to the mass of the active material is preferably within a range of 0.01% by mass to 10% by mass. The battery active substance according to the first embodiment in which the mass of the binding phase is within a range of 0.01% by mass to 10% by mass can further improve an adhesive property, and can prevent the conductivity of an electrode which can be attained by the active substance from being impaired.

The at least one material selected from the group consisting of hydroxyalkyl cellulose and carboxymethyl cellulose and the binding phase can be mixed in an optional ratio. The ratio of the total mass of the at least one material to the sum of the total mass of the at least one material and the mass of the binding phase is preferably, for example, within a range of 10% by mass to 90% by mass, more preferably within a range of 40% by mass to 80% by mass, and still more preferably within a range of 50% by mass to 70% by mass.

Next, an example of the active substance according to the first embodiment will be specifically described with reference to FIG. 1.

FIG. 1 is a schematic sectional view of the active substance of an example according to the first embodiment.

A battery active substance 40 shown in FIG. 1 includes a plurality of composites 41 and a binding phase 45 positioned between the composites 41.

Each of the composites 41 includes active material particle 42. The active material particle 42 shown in FIG. 1 includes primary particles and secondary particles of TiO₂(B).

Each of the composites 41 further includes a coating layer 43. The entire surface of the active material particle 42 is coated with the coating layer 43. The coating layer 43 includes at least one material selected from the group of hydroxyalkyl methylcellulose and carboxymethyl cellulose. The coating layer 43 further includes carbon black 44 as a conductive agent. The carbon black 44 is uniformly dispersed in the coating layer 43.

The binding phase 45 positioned between the composites 41 includes at least one material selected from the group consisting of polyvinylidene fluoride, styrene-butadiene rubber, and an acrylic-based polymer. The binding phase 45 binds the plurality of composites 41.

According to the first embodiment mentioned above, the active substance is provided. Because such an active substance can suppress the reaction between the active material particle and the nonaqueous electrolyte and the reaction between the active material particle and the binding phase, in a nonaqueous electrolyte battery including the active substance, problems such as deterioration of electrode performance, an increase in internal resistance, and deterioration of the nonaqueous electrolyte in the nonaqueous electrolyte battery can be suppressed. As a result of such, the active substance according to the first embodiment can attain a nonaqueous electrolyte battery which can exhibit a high capacity retention after a cycle and suppress an increase in a resistance value through a cycle.

### Second Embodiment

According to a second embodiment, there is provided an electrode. The electrode includes a current collector and an active-substance layer provided on the current collector. The active-substance layer includes the active substance according to the first embodiment.

Next, the electrode according to the second embodiment will be described in more detail.

The electrode according to the second embodiment includes the current collector.

As the current collector, for example, a metal foil such as an aluminum foil or an aluminum alloy foil can be used. The thicknesses of the aluminum foil and aluminum alloy foil are preferably 20 μm or less, and more preferably 15 μm or less. Thereby, the weight of the electrode can be reduced while the strength of the electrode is maintained. The purity of the aluminum foil is preferably 99% by mass or more. The aluminum alloy preferably contains an element such as Mg, Zn, or Si. On the other hand, when the aluminum alloy contains a transition metal such as Fe, Cu, Ni, or Cr, the content of the transition metal is preferably 1% by mass or less.

The shape of the current collector is not particularly limited. The current collector may have a band shape, for example.

The electrode according to the second embodiment further includes an active-substance layer. The active-substance layer is provided on the current collector. The active-substance layer may be provided on any one of surfaces of the current collector, or may be provided on both the surfaces of the current collector.

The active-substance layer includes the active substance according to the first embodiment. The active-substance layer can also include an additional material. Examples of the additional material include hydroxyalkyl cellulose, carboxymethyl cellulose, polyvinylidene fluoride, styrene-butadiene rubber, and an acrylic-based polymer which are not included in the active substance according to the first embodiment, or an additional binder other than these materials, and an additional conductive agent.

As described in the first embodiment, the coating layer coats the active material particle in each of the composites in the battery active substance according to the first embodiment. Therefore, the coating layer can suppress the reaction between the additional binder other than hydroxyalkyl cellulose, carboxymethyl cellulose, polyvinylidene fluoride, styrene-butadiene rubber, and an acrylic-based polymer which may be included in the active-substance layer included in the electrode according to the second embodiment and the active material particles, which makes it possible to suppress the decomposition of the binder.

The content of the active material particle in the active-substance layer to the mass of the active-substance layer is preferably 70% by mass to 97% by mass. The content of the conductive agent in the active-substance layer to the mass of the active-substance layer is preferably 1% by mass to 10% by mass. The content of the binder including at least one material selected from the group consisting of hydroxyalkyl cellulose and carboxymethyl cellulose, and at least one material selected from the group of polyvinylidene fluoride, styrene-butadiene rubber, and an acrylic-based polymer to the mass of the active-substance layer is preferably 2% by mass to 20% by mass. When the content of the conductive agent is 1% by mass or more, the active-substance layer can exhibit an excellent current-collecting performance. On the other hand, from the viewpoint of improving a capacity, the content of the conductive agent is preferably 10% by mass or less. When the content of the binder is 2% by mass or more, an excellent binding ability between the active-substance layer and the current collector can be exhibited. This means that a more excellent capacity retention can be expected to be exhibited after a cycle. On the other hand, from the viewpoint of improving a capacity, the content of the binder is preferably 20% by mass or less.

The current collector can include an active-substance-non-supporting portion. The active-substance layer is not provided on the surface of the active-substance-non-supporting portion. The active-substance-non-supporting portion can function as a current-correcting tab.

The electrode according to the second embodiment is produced by the following method, for example. The active substance according to the first embodiment is suspended in a commonly-used solvent, to prepare a slurry. The slurry is applied to the current collector, and dried to form the active-substance layer. Then, the active substance layer is subjected to pressing.

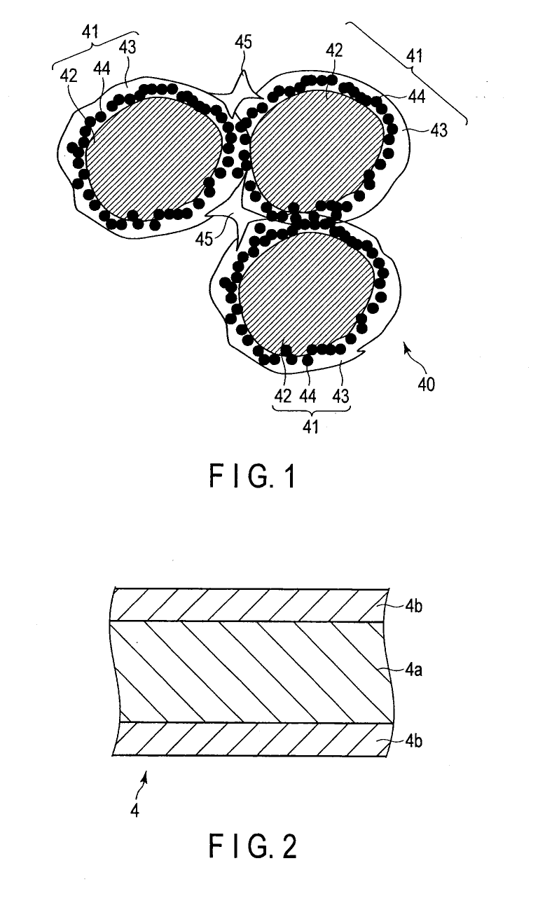

Next, an example of the electrode according to the second embodiment will be specifically described with reference to FIG. 2.

FIG. 2 is a schematic sectional view of the electrode of an example according to the second embodiment.

An electrode 4 shown in FIG. 2 includes a current collector 4a. The current collector 4a is an aluminum foil having a band-like plane shape.

The electrode 4 includes an active-substance layer 4b provided on each of both surfaces of the current collector 4a. The active-substance layer 4b includes a battery active substance 40 described earlier with reference to FIG. 1.

According to the second embodiment mentioned above, there is provided the electrode. Because the electrode according to the second embodiment includes the battery active material according to the first embodiment, the electrode can attain a nonaqueous electrolyte battery which can exhibit a high capacity retention after a cycle and suppress an increase in a resistance value through a cycle.

### Third Embodiment

According to a third embodiment, there is provided a nonaqueous electrolyte battery. The nonaqueous electrolyte battery includes a positive electrode, the electrode according to the second embodiment as a negative electrode, and a nonaqueous electrolyte.

Next, the nonaqueous electrolyte battery according to the third embodiment will be described in detail.

The nonaqueous electrolyte battery according to the third embodiment includes a positive electrode.

The positive electrode can include a positive electrode current collector and a positive electrode material layer provided on the positive electrode current collector.

The positive electrode material layer may be provided on any one of surfaces of the positive electrode current collector, or may be provided on both the surfaces of the positive electrode current collector.

The positive electrode material layer can include a positive active material. The positive electrode material layer can optionally include a conductive agent and a binder.

The positive electrode current collector can include a positive-electrode-active-material-non-supporting portion. The positive electrode material layer is not provided on the surface of the positive-electrode-active-material-non-supporting portion. The positive-electrode-active-material-non-supporting portion can function as a current-collecting tab of the positive electrode.

The positive electrode can be produced by the following method, for example. The positive electrode active material, the binder, and the conductive agent are suspended in a suitable solvent, to prepare a slurry. The slurry is applied to the surface of the positive electrode current collector, and dried to form the positive electrode material layer. Then, the positive electrode material layer is subjected to pressing. The positive electrode may also be produced by making the positive electrode active material, the binder, and the conductive agent into a pellet, and then disposing the pellet as the positive electrode material layer on the positive electrode current collector.

The nonaqueous electrolyte battery according to the third embodiment further includes a negative electrode. The negative electrode is the electrode according to the second embodiment. As described for the second embodiment, the negative electrode includes a current collector, i.e., a negative electrode current collector, and an active-substance layer provided on the current collector, i.e., a negative electrode material layer. The negative electrode material layer includes the active substance according to the first embodiment. The negative electrode current collector can include a negative-electrode-material-non-supporting portion. The negative electrode material layer is not provided on surface of the negative-electrode-material-non-supporting portion. The negative-electrode-material-non-supporting portion can function as a current-collecting tab of the negative electrode.

The positive electrode and the negative electrode are provided such that the positive electrode material layer and the negative electrode material layer are opposed to each other, thereby making it possible to constitute an electrode group. A member allowing to pass lithium ions and not to pass electricity, e.g., a separator can be provided between the positive electrode material layer and the negative electrode material layer.

The electrode group can take various structures. The electrode group may have a stack-type structure, or may have a coiled-type structure. The stack-type structure has a structure where a plurality of negative electrodes, a plurality of positive electrodes, and separators are laminated with each of the separators sandwiched between each of the negative electrodes and each of the positive electrodes, for example. The electrode group having a coiled-type structure may be a can-type structure obtained by coiling a product obtained by laminating a negative electrode and a positive electrode with a separator sandwiched therebetween, for example, or may be a flat-type structure obtained by pressing the can-type structure.

The current-collecting tab of the positive electrode can be electrically connected to a positive electrode terminal. Similarly, the current-collecting tab of the negative electrode can be electrically connected to a negative electrode terminal. The positive electrode terminal and the negative electrode terminal can be extended from the electrode group.

The electrode group may be housed in an exterior member. The exterior member may have a structure where the positive electrode terminal and the negative electrode terminal can be extended to the outside of the exterior member. Alternatively, the exterior member may include two external terminals each of which are electrically connected to one of the positive electrode terminal and the negative electrode terminal.

The nonaqueous electrolyte battery according to the third embodiment further includes a nonaqueous electrolyte. The nonaqueous electrolyte may be impregnated in the electrode group. The nonaqueous electrolyte may be housed in the exterior member.

Hereinafter, materials for the members which can be used in the nonaqueous electrolyte battery according to the third embodiment will be described.

(1) Negative Electrode

The materials which can be used in the negative electrode are those described in the first embodiment.

(2) Positive Electrode

As the positive electrode active material, various oxides, sulfides, and polymers or the like can be used.

Examples of the positive electrode active material include a manganese dioxide (for example, MnO₂), an iron oxide, a copper oxide, a nickel oxide, a lithium-manganese composite oxide (for example, LiₓMn₂O₄ or LiₓMnO₂), a lithium-nickel composite oxide (for example, LiₓNiO₂), a lithium-cobalt composite oxide (for example, LiₓCoO₂), a lithium-nickel-cobalt composite oxide (for example, LiNi_{1-y}Co_{y}O₂), a lithium-manganese-cobalt composite oxide (for example, LiMn_{y}Co_{1-y}O₂), a lithium-manganese-nickel composite oxide having a spinel structure (for example, LiₓMn_{2-y}Ni_{y}O₄), a lithium-phosphorous oxide having an olivine structure (for example, LiₓFePO₄, LiₓFe_{1-y}Mn_{y}PO₄, or LiₓCoPO₄ or the like), an iron sulfate (for example, Fe₂(SO₄)₃), and a vanadium oxide (for example, V₂O₅). There can also be used organic materials and inorganic materials; for example, conductive polymer materials such as polyaniline and polypyrrole, disulfide-based polymer materials, sulfur (S), or carbon fluoride.

As the positive electrode active material, a compound which can provide a high battery voltage is more preferably used. Examples of such a compound include a lithium-manganese composite oxide (for example, LiₓMn₂O₄), a lithium-nickel composite oxide (for example, LiₓNiO₂), a lithium-cobalt composite oxide (for example, LiₓCoO₂), a lithium-nickel-cobalt composite oxide (for example, LiNi_{1-y}Co_{y}O₂), a lithium-manganese-nickel composite oxide having a spinel structure (for example, LiₓMn_{2-y}Ni_{y}O₄), a lithium-manganese-cobalt composite oxide (for example, LiMn_{y}Co_{1-y}O₂), and a lithium-iron phosphate (for example, LiₓFePO₄). In the above formula, x and y are preferably within a range of 0 to 1, respectively.

A lithium-nickel-cobalt-manganese composite oxide represented by the formula LiₐNi_{b}Co_{c}Mn_{d}O₂ can be used as the positive electrode active material. In the formula, a, b, c, and d satisfy the relationship represented by the inequality 0.1≦a≦1.1, 0.1≦b≦0.5, 0≦c≦0.9, and 0.1≦d≦0.5, respectively.

The positive electrode active material may include any one of the above compounds singly or may include two or more of the above compounds.

In a battery including a nonaqueous electrolyte containing an ordinarly-temperature-molten salt, it is preferable to use a compound selected from the group consisting of a lithium-iron phosphate, LiₓVPO₄F (0≦x≦1), a lithium-manganese composite oxide, a lithium-nickel composite oxide, and a lithium-nickel-cobalt composite oxide. According to such a structure, the reactivity between the positive electrode active material and the ordinary-temperature-molten salt is lowered, and therefore, cycle performance can be further improved.

The conductive agent is used, as needed, to improve a current-collecting performance and to suppress the contact resistance between the active material and the positive electrode current collector. Examples of the conductive agent include a carbon material such as acetylene black, carbon black, graphite, carbon nanofiber, and carbon nanotubes.

The binder is used, as needed, to bind the active material, the conductive agent, and the positive electrode current collector with each other. Examples of the binder include polytetrafluoroethylene (PTFE), polyvinylidene fluoride, fluoro-rubber, acryl rubber, and an acryl resin. These materials may be used either singly or in combinations of two or more.

The positive electrode layer preferably includes the active material, the conductive agent, and the binder in ratios of 80% by mass to 95% by mass, 3% by mass to 18% by mass, and 2% by mass to 17% by mass, respectively.

When the content of the conductive agent is 3% by mass or more, the aforementioned effect can be exhibited. When the content of the conductive agent is 18% by mass or less, the decomposition of the nonaqueous electrolyte which occurs on the surface of the conductive agent when a battery is stored at a high temperature can be suppressed.

When the content of the binder is 2% by mass or more, sufficient positive electrode strength is obtained. Because the binder is an insulation material, the content of the binder is preferably 17% by mass or less. Thereby, an increase in internal resistance can be suppressed.

The positive electrode current collector is preferably an aluminum foil, or an aluminum alloy foil containing at least one element selected from the group consisting of Mg, Zn, and Si. The thickness of the aluminum foil or aluminum alloy foil is preferably 20 μm or less, and more preferably 15 μm or less. The purity of the aluminum foil is preferably 99% by mass or more. When transition metals such as Fe, Cu, Ni, and Cr are contained, the content of these transition metals is preferably 1% by mass or less.

The density of the positive electrode layer is preferably 3 g/cm³ or more.

(3) Nonaqueous Electrolyte

As the nonaqueous electrolyte, for example, a liquid nonaqueous electrolyte may be used. The liquid nonaqueous electrolyte is prepared by dissolving an electrolyte in an organic solvent. The concentration of the electrolyte in the liquid nonaqueous electrolyte is preferably 0.5 mol/L to 2.5 mol/L.

Examples of the electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethasulfonate (LiCF₃SO₃), and bistrifluoromethylsulfonylimide lithium (LiN(CF₃SO₂)₂), and mixtures of these compounds. The electrolyte is preferably one which is poorly oxidized at a high potential, and LiPF₆ is the most preferable.

Examples of the organic solvent include a cyclic carbonate such as propylene carbonate (PC), ethylene carbonate (EC), or vinylene carbonate (VC); a chain carbonate such as diethyl carbonate (DEC), dimethyl carbonate (DMC), or methylethyl carbonate (MEC); a cyclic ether such as tetrahydrofuran (THF), 2-methyltetrahydrofuran (2MeTHF), or dioxolan (DOX); a chain ether such as dimethoxyethane (DME) or diethoxyethane (DEE); γ-butyrolactone (GBL), acetonitrile (AN), and sulfolane (SL). These organic solvents may be used either singly or in combinations of two or more.

Mixed solvents prepared by mixing GBL and at least two of PC, EC and γ-butyrolactone GBL are suitably used in a battery used under a high-temperature environment, for example, a battery mounted on vehicles.

An ordinary-temperature-molten salt containing lithium ions may be used as the liquid nonaqueous electrolyte.

The ordinary-temperature-molten salt means a salt at least part of which can exist in a liquid state at ordinary temperature. The term “ordinary temperature” means a temperature range in which power sources are assumed to usually operate. The temperature range is, for example, from an upper limit of about 120° C. or about 60° C., depending on the case, to a lower limit of about −40° C. or about −20° C., depending on the case.

As the lithium salt, one having a wide potential window and usually utilized in a nonaqueous electrolyte battery is used. Examples of the lithium salt include, though are not limited to, LiBF₄, LiPF₆, LiClO₄, LiCF₃SO₃, LiN(CF₃SO₂)₂, LiN(C₂F₅SO₂), and LiN(CF₃SC(C₂F₅SO₂))₃. These lithium salts may be used either singly or in combinations of two or more.

The content of the lithium salt is preferably 0.1 to 3 mol/L, and particularly preferably 1 to 2 mol/L. When the content of the lithium salt is 0.1 mol/L or more, the resistance of the electrolyte can be decreased. Thereby, the discharge performance of a battery under large-current/low-temperature conditions can be improved. When the content of the lithium salt is 3 mol/L or less, the melting point of the electrolyte can be kept low, enabling the electrolyte to keep a liquid state at ordinary temperature.

The ordinary-temperature-molten salt has, for example, a quaternary ammonium organic cation or an imidazolium cation.

Examples of the quaternary ammonium organic cation include an imidazolium ion such as an ion of dialkylimidazolium or trialkylimidazolium, a tetraalkylammonium ion, an alkylpyridium ion, a pyrazolium ion, a pyrrolidinium ion, and a piperidinium ion. Particularly, the imidazolium cation is preferable.

Examples of the tetraalkylammonium ion include, though are not limited to, a trimethylethylammonium ion, a trimethylpropylammonium ion, a trimethylhexylammonium ion, and a tetrapentylammonium ion.

Examples of the alkylpyridium ion include, though are not limited to, a N-methylpyridium ion, a N-ethylpyridinium ion, a N-propylpyridinium ion, a N-butylpyridinium ion, a 1-ethyl-2-methylpyridinium ion, a 1-butyl-4-methylpyridinium ion, and a 1-butyl-2,4-dimethylpyridinium ion.

The ordinary-temperature-molten salt having a cation may be used either singly or in combinations of two or more.

Examples of the imidazolium cation include, though are not limited to, a dialkylimidazolium ion, and a trialkylimidazolium ion.

Examples of the dialkylimidazolium ion include, though are not limited to, a 1,3-dimethylimidazolium ion, a 1-ethyl-3-methylimidazolium ion, a 1-methyl-3-ethylimidazolium ion, a 1-methyl-3-butylimidazolium ion, and a 1-butyl-3-methylimidazolium ion.

Examples of the trialkylimidazolium ion include, though are not limited to, a 1,2,3-trimethylimidazolium ion, a 1,2-dimethyl-3-ethylimidazolium ion, a 1,2-dimethyl-3-propylimidazolium ion, and a 1-butyl-2,3-dimethylimidazolium ion.

The normal temperature molten salts having a cation may be used either singly or in combinations of two or more.

(4) Separator

The separator may be made of a porous film including a polyethylene, polypropylene, cellulose, or polyvinylidene fluoride (PVDF), or a synthetic resinous nonwoven fabric, for example. The porous film made of polyethylene or polypropylene melts at a certain temperature and can block electric current. The safety of the battery can be further improved by using these films as the separator.

(5) Positive Electrode Terminal

The positive electrode terminal may be made of a material which has conductivity and is electrically stable in a voltage range from 3 V (vs. Li/Li⁺) to 5 V (vs. Li/Li⁺) relative to lithium metal. The positive electrode terminal is preferably made of aluminum or an aluminum alloy containing at least one element selected from Mg, Ti, Zn, Mn, Fe, Cu, and Si. The positive electrode terminal is preferably made of the same material as that of the positive electrode current collector to reduce the contact resistance with the positive electrode current collector.

(6) Negative Electrode Terminal

The negative electrode terminal may be made of a material which has conductivity and is electrochemically stable in a voltage range from 0.4 V (vs. Li/Li⁺) to 3 V (vs. Li/Li⁺). Examples of such a material include aluminum or an aluminum alloy containing at least one element selected from Mg, Ti, Zn, Mn, Fe, Cu, and Si. The negative electrode terminal is preferably made of the same material as that of the negative electrode current collector to reduce the contact resistance with the negative electrode current collector.

(7) Exterior Member

As the exterior member, for example, a container formed of a laminate film or a metal container can be used.

The shape and size of the exterior member are optionally designed in accordance with the dimensions of the battery. Examples of the shape of the exterior member include a flat type (thin type), an angular type, a cylinder type, a coin type, a button type, a sheet type, and a laminate type. An exterior member for a miniature battery to be mounted in, for example, a mobile electronic device, or an exterior member for a large battery to be mounted on a two- or four-wheel vehicle or the like is used as the exterior member.

The laminate film is a multilayer film which includes a metal layer and a resin film covering the metal layer. The metal layer is preferably made of an aluminum foil or an aluminum alloy foil. The weight of the battery using the laminate film including the aluminum foil or the aluminum alloy foil as the exterior member can be reduced. As the aluminum alloy, an alloy containing an element such as Mg, Zn, or Si is preferable. When the alloy contains a transition metal such as Fe, Cu, Ni, or Cr, the content of the transition metal is preferably 1% by mass or less. Thereby, long-term reliability and heat radiation ability under a high-temperature environment can be outstandingly improved. The resin layer may reinforce the metal layer. The resin layer may be made of a polymer such as a polypropylene (PP), polyethylene (PE), nylon, or polyethylene terephthalate (PET).

The thickness of the laminate film forming the exterior member is preferably 0.5 mm or less, and more preferably 0.2 mm or less. The laminate film can be molded into a desired shape by thermal fusion bonding.

The metal container may be made of aluminum, an aluminum alloy, iron, and stainless or the like. The aluminum alloy preferably contains an element such as Mg, Zn, or Si. When the alloy contains a transition metal such as Fe, Cu, Ni, or Cr, the content of the transition metal is preferably 1% by mass or less. The thickness of the metal plate forming the metal container is preferably 1 mm or less, more preferably 0.5 mm or less, and still more preferably 0.2 mm or less.

Next, some examples of a nonaqueous electrolyte battery according to a third embodiment will be specifically described with reference to the drawings.

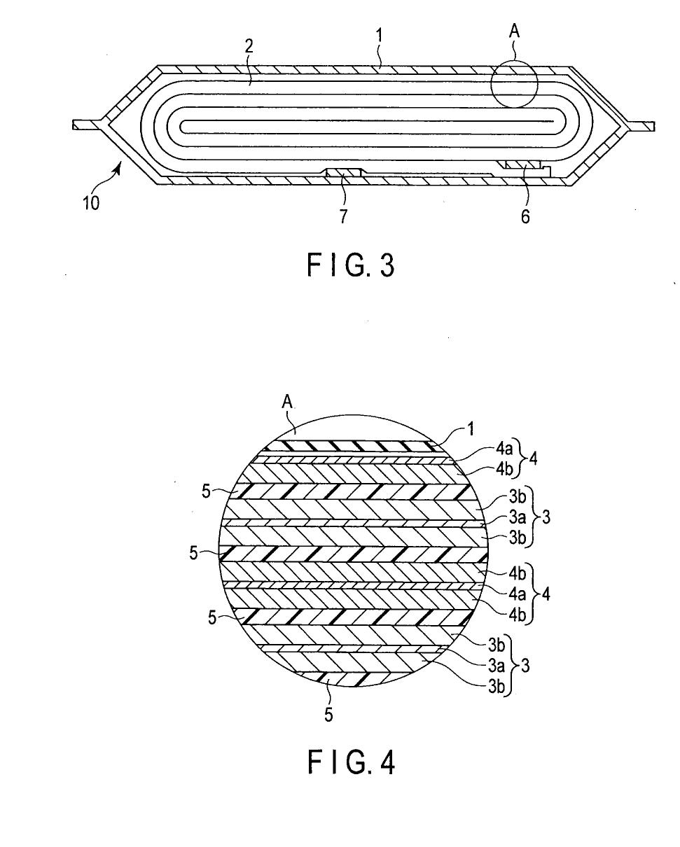

First, a nonaqueous electrolyte battery of a first example according to the third embodiment will be described with reference to FIGS. 3 and 4.

FIG. 3 is a schematic sectional view of the nonaqueous electrolyte battery of the first example according to the third embodiment. FIG. 4 is an enlarged sectional view of a part A of the nonaqueous electrolyte battery shown in FIG. 3.

A nonaqueous electrolyte battery 10 shown in FIG. 3 includes an exterior member 1 and an electrode group 2 housed in the exterior member 1.

The exterior member 1 has a baggy shape. The exterior member 1 is a laminate container.

A nonaqueous electrolyte (not shown) is further housed in the exterior member 1.

As shown in FIG. 4, the electrode group 2 includes a positive electrode 3, a negative electrode 4, and a plurality of separators 5. As shown in FIG. 3, the electrode group 2 has a structure in which a laminate is spirally coiled. This laminate has a structure in which the separator 5, the positive electrode 3, another separator 5, and the negative electrode 4 are laminated on each other in this order. This coiled electrode group 2 can be produced by spirally coiled the laminate such that the negative electrode 4 is positioned on the outermost periphery, then extracting a core, and thereafter pressing under heating.

As shown in FIG. 4, the positive electrode 3 includes a band-like positive electrode current collector 3a and a positive electrode material layer 3b formed on each of both surfaces of the positive electrode current collector 3a. The positive electrode current collector 3a includes a positive-electrode-material-non-supporting portion (not shown) near the outermost periphery of the electrode group 2. The positive electrode material layer 3b is not formed on the surface of the positive-electrode-material-non-supporting portion. The positive electrode material layer 3b includes a positive electrode active material (not shown), a conductive agent (not shown), and a binder (not shown).

As shown in FIG. 4, the negative electrode 4 includes a band-like negative electrode current collector 4a and a negative electrode material layer 4b formed on each of both surfaces of the negative electrode current collector 4a. The negative electrode current collector 4a includes a negative-electrode-material-non-supporting portion (not shown) on the outermost periphery of the electrode group 2. The negative electrode material layer 4b is not formed on the surface of the negative-electrode-material-non-supporting part. The negative electrode material layer 4b includes a negative electrode active material (not shown), a conductive agent (not shown), and a binder (not shown).

A positive electrode terminal 6 shown in FIG. 3 is electrically connected to the positive-electrode-material-non-supporting portion of the positive electrode 3. The positive-electrode-material-non-supporting part and the positive electrode terminal 6 can be connected by ultrasonic welding, for example. Similarly, a negative electrode terminal 7 shown in FIG. 3 is electrically connected to the negative-electrode-material-non-supporting part of the negative electrode 4. The negative-electrode-material-non-supporting portion and the negative electrode terminal 7 can be connected by ultrasonic welding, for example. The positive electrode terminal 6 and the negative electrode terminal 7 are extended to the outside from the exterior member 1.

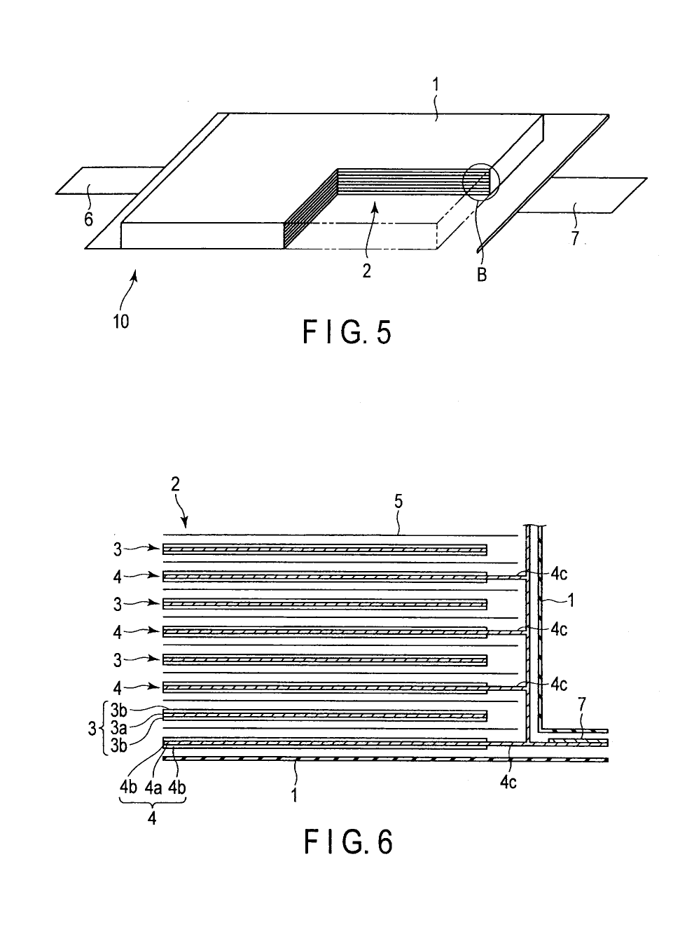

Next, another example of the nonaqueous electrolyte battery according to the third embodiment will be described with reference to FIGS. 5 and 6.

FIG. 5 is a partially broken schematic perspective view of a nonaqueous electrolyte battery of a second example according to the third embodiment. FIG. 6 is an enlarged sectional view of a part B of the nonaqueous electrolyte battery shown in FIG. 5.

A nonaqueous electrolyte battery 10 shown in FIGS. 5 and 6 is largely different from the nonaqueous electrolyte battery of the first example shown in FIGS. 3 and 4 in that an electrode group 2 has a stack-type structure instead of a coiled-type structure.

The nonaqueous electrolyte battery 10 shown in FIGS. 5 and 6 includes an exterior member 1 made of a laminate film and a stack-type electrode group 2 housed in the exterior member 1.

The stack-type electrode group 2 has a structure schematically shown in FIG. 6. More specifically, the stack-type electrode group 2 has a structure in which the plurality of band-like positive electrodes 3 and the plurality of band-like negative electrodes 4 are alternately laminated such that a positive electrode material layer 3b and a negative electrode material layer 4b are opposed to each other with a separator 5 sandwiched therebetween.

As shown in FIG. 6, each negative electrode current collector 4a includes a negative-electrode-material-non-supporting portion 4c provided on one end and extending from the stack-type electrode group 2. The negative-electrode-material-non-supporting portions 4c function as current-collecting tabs of the negative electrode. As shown in FIG. 6, the plurality of current-collecting tabs 4c of the negative electrode are bundled into one group, and are electrically connected to a negative electrode terminal 7.

Similarly, although not illustrated in the figures, each positive electrode current collector 3a includes a positive-electrode-material-non-supporting portion extending from the laminate-type electrode group 2. These positive-electrode-material-non-supporting portions function as current-collecting tabs of the positive electrode. Although not illustrated in the figures, the plurality of current-collecting tabs of the positive electrode are bundled into one group, and are electrically connected to a positive electrode terminal 6.

As shown in FIG. 5, the positive electrode terminal 6 and the negative electrode terminal 7 extend in mutually opposite directions from the exterior member 1.

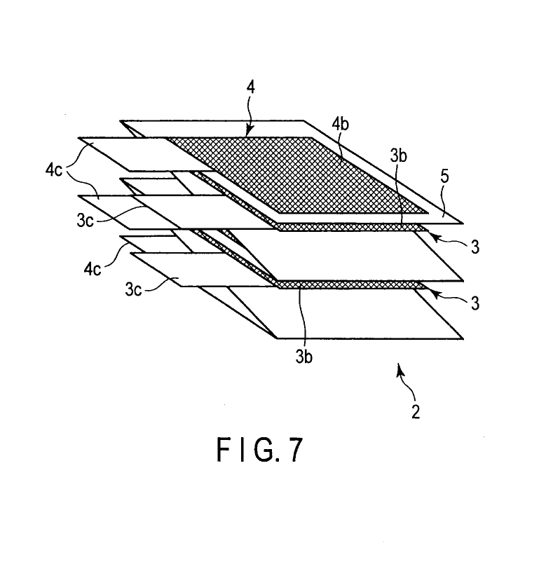

Next, another example of the nonaqueous electrolyte battery according to the third embodiment will be described with reference to FIG. 7.

FIG. 7 is a schematic development perspective view of an electrode group included in a nonaqueous electrolyte battery of a third example according to the third embodiment.

A nonaqueous electrolyte battery 10 including an electrode group 2 shown in FIG. 7 is largely different from the nonaqueous electrolyte battery of the first example shown in FIGS. 3 and 4 and the nonaqueous electrolyte of the second example shown in FIGS. 5 and 6 in that a separator 5 is a band-like separator folded in a zigzag pattern.

The electrode group 2 shown in FIG. 7 includes the plurality of sheet-like positive electrodes 3, the plurality of sheet-like negative electrodes 4, and a band-like separator 5 folded in a zigzag pattern.

The flag-like positive electrode 3 includes a main part having a surface having a positive electrode material layer 3b formed thereon, and a narrow part 3c having a surface on which a positive electrode material layer 3b is not formed. The narrow part 3c functions as a current-collecting tab of the positive electrode. Similarly, the flag-like negative electrode 4 includes a main part having a surface having a negative electrode material layer 4b formed thereon, and a narrow part 4c having a surface on which a negative electrode material layer 4b is not formed. The narrow part 4c functions as a current-collecting tab of the negative electrode.

The negative electrode 4 is laminated on the uppermost layer of the separator 5 folded in a zigzag pattern such that the main part 4b of the negative electrode 4 is placed on the uppermost layer. The positive electrode 3 and the negative electrode 4 are alternately inserted into spaces formed by folding the separator 5 in a zigzag pattern. Thereby, the main part of the positive electrode 3, i.e., the positive electrode material layer 3b, and the main part of the negative electrode 4, i.e., the negative electrode material layer 4b are opposed to each other with the separator 5 interposed therebetween.

The current-collecting tab 3c of the positive electrode and the current-collecting tab 4c of the negative electrode extend in the same direction from the electrode group 2. In the electrode group 2 shown in FIG. 7, in the lamination direction of the electrode group 2, the current-collecting tabs 3c of the positive electrode are opposed to each other, and the current-collecting tabs 4c of the negative electrode are opposed to each other. However, the current-collecting tab 3c of the positive electrode and the current-collecting tab 4c of the negative electrode are not opposed to each other. Although not illustrated in the figures, the plurality of current-collecting tabs 3c of the positive electrode are bundled into one group, and are electrically connected to a positive electrode terminal (not shown). Similarly, the plurality of current-collecting tabs 4c of the negative electrode are bundled into one group, and are electrically connected to a negative electrode terminal (not shown).

The nonaqueous electrolyte battery according to the third embodiment mentioned above includes the electrode according to the second embodiment. Therefore, the nonaqueous electrolyte battery according to the third embodiment can exhibit a high capacity retention after a cycle and suppress an increase in a resistance value through a cycle.

### Fourth Embodiment

According to a fourth embodiment, there is provided a battery pack. The battery pack includes the nonaqueous electrolyte battery according to the third embodiment.

The structure of a fourth battery pack is appropriately changed according to its use. According to the fourth embodiment, as described earlier, there can be provided a battery pack which is suitably used in applications in which excellent cycle performance and large-current performance are required. Specifically, there can be provided a battery pack which is suitably used for power sources for digital cameras or power sources mounted on vehicles such as two- to four-wheel hybrid electric vehicles, two- to four-wheel electric vehicles, and assist bicycles.

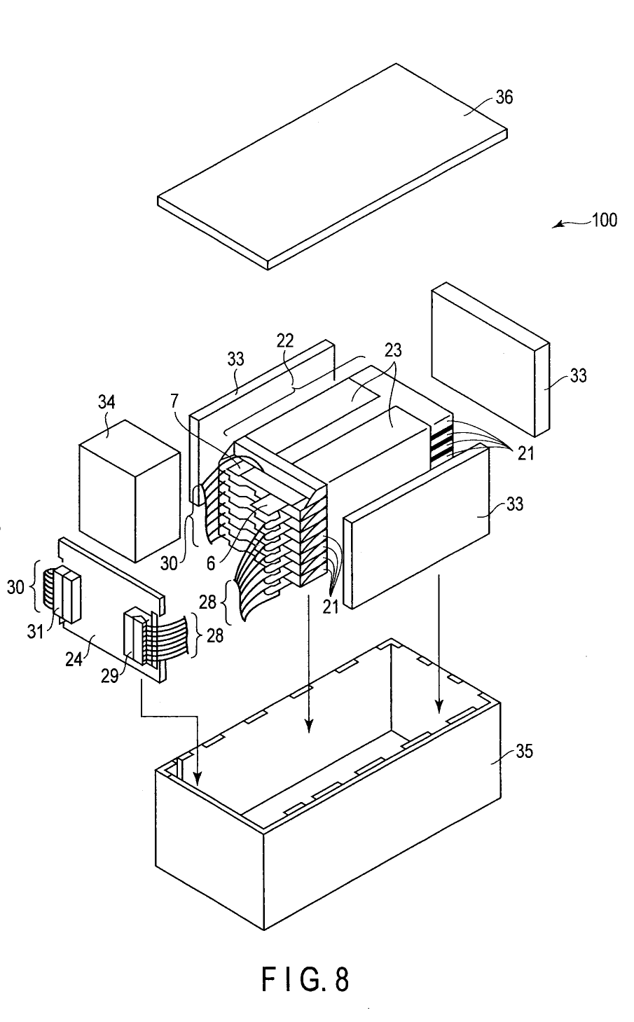

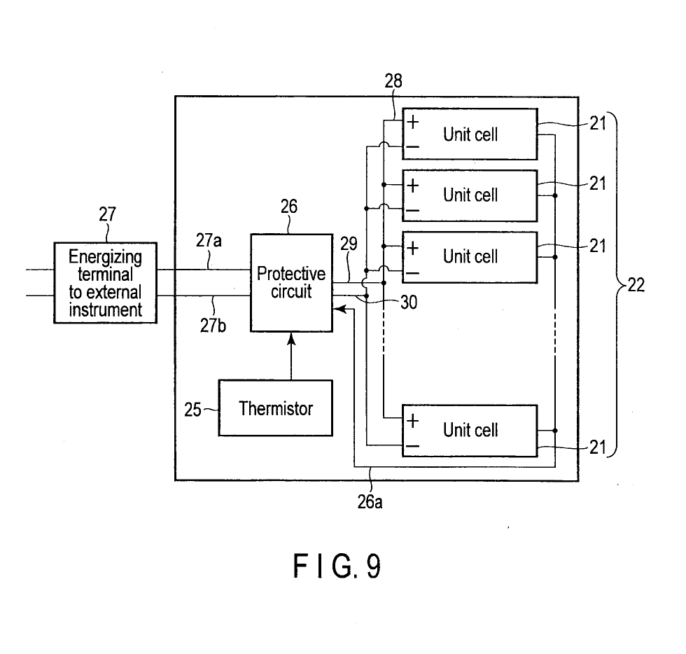

Next, an example of the battery pack according to the fourth embodiment will be described with reference to FIGS. 8 and 9.

FIG. 8 is a schematic exploded perspective view of the battery pack of an example according to the fourth embodiment. FIG. 9 is a block diagram showing an electric circuit of the battery pack shown in FIG. 8.

A battery pack 100 shown in FIGS. 8 and 9 includes the eight batteries (unit cells) 21 according to the third embodiment. In the eight unit cells 21, all positive electrode terminals 6 and all negative electrode terminals 7 extend in the same direction. As shown in FIGS. 8 and 9, the plurality of cells 21 is connected in parallel to constitute a battery module 22. The plurality of cells 21 constituting the battery module 22 is integrated by using an adhesive tape 23 as shown in FIG. 8.

A printed wiring board 24 is disposed so as to be opposed to a lateral surface of the battery module 22 from which the positive electrode terminals 6 and the negative electrode terminals 7 extend. As shown in FIG. 9, a thermistor 25, a protective circuit 26, and an energizing terminal 27 to an external instrument are mounted to the printed wiring board 24.

As shown in FIGS. 8 and 9, the positive electrode terminal 6 of each of the eight unit cells 21 constituting the battery module 22 is electrically connected to a positive electrode connector 29 of the protective circuit 26 of the printed wiring board 24 via a positive electrode lead 28. Similarly, the negative electrode terminal 7 of each of the eight unit cells 21 constituting the battery module 22 is electrically connected to a negative electrode connector 31 of the protective circuit 26 of the printed wiring board 24 via a negative electrode lead 30.

The thermistor 25 detects the temperature of the unit cell 21. A detection signal for the temperature of the cell 21 is transmitted to the protective circuit 26 from the thermistor 25. The protective circuit 26 can interrupt a plus wiring 27a and a minus wiring 27b between the protective circuit and the energizing terminal 27 to an external instrument under predetermined conditions. The predetermined conditions includes a temperature detected by the thermistor 25 which is equal to or more than a predetermined temperature, and detection of an over-charge, over-discharge, and over-current of the unit cell 21, or the like. The detection method may be performed on each of the unit cells 21 or the entire battery module 22. When the detection is performed on each of the unit cells 21, a battery voltage may be detected, or a positive electrode potential or a negative electrode potential may be detected. A lithium electrode to be used as a reference electrode is inserted into each of the unit cells 21, and thereby the detection can be performed on the entire battery module 22. In the case of FIG. 9, a wiring 26a for voltage detection is connected to each of the unit cells 21. The detection signals are transmitted to the protective circuit 26 via the wirings 26a.

In the battery module 22, on each of three lateral surfaces other than the lateral surface from which the positive electrode terminals 6 and the negative electrode terminals 7 are projected, a protection sheet 33 made of rubber or a resin is disposed. A protection block 34 made of rubber or a resin, in the form of a block, is disposed between the lateral surface from which the positive electrode terminals 6 and the negative electrode terminals 7 are projected and the printed wiring board 24.

The battery module 22 is housed in a housing container 35 together with the protection sheets 33, the protection block 34, and the printed wiring board 24. More specifically, the protection sheets 33 are disposed on inner surfaces in a length direction and one of inner surfaces in a width direction of the housing container 35, and the printed wiring board 24 is disposed on the other inner surface in the width direction of the housing container 35. The battery module 22 is positioned in a space defined by the protection sheets 33 and the printed wiring board 24. A cover 36 is attached to a top surface of the housing container 35.

A heat-shrinkable tape may be used in place of the adhesive tape 23 for fixing the battery module 22. In this case, the battery module is bound by disposing the protection sheet on each of the lateral surfaces of the battery module, looping the heat-shrinkable tube around, and thereafter subjecting the heat-shrinkable tube to heat shrinkage.

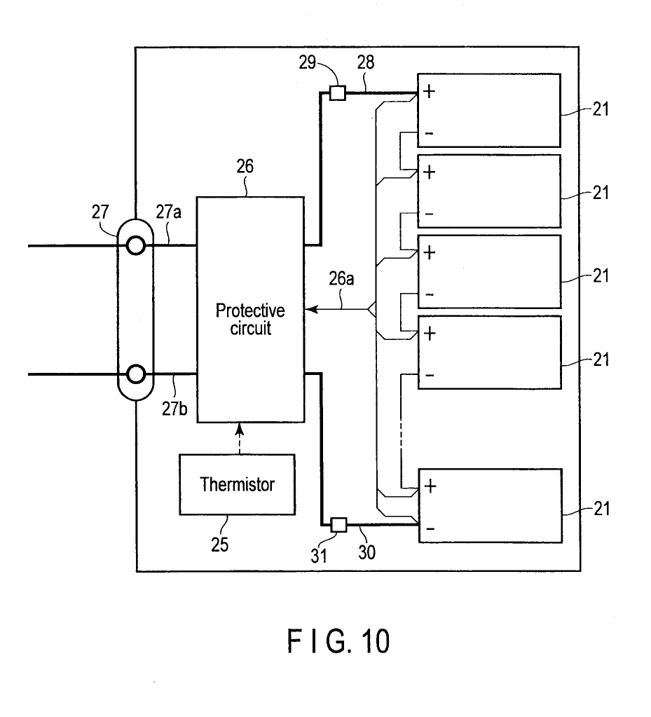

Though the unit cells 21 are connected in parallel in the battery pack 100 shown in FIGS. 8 and 9, they may be connected in series as shown in FIG. 10. Of course, the assembled battery packs 100 may be connected in series or in parallel.

The battery pack according to the fourth embodiment mentioned above includes the nonaqueous electrolyte battery according to the third embodiment. Therefore, the battery pack according to the fourth embodiment can exhibit a high capacity retention after a cycle, and can suppress an increase in a resistance value through a cycle.

### EXAMPLES

Hereinafter, examples will be described. The following examples are not intended to limit the scope of the present invention unless the gist of the invention is exceeded.

<Production of Electrode>

### Example 1-1

In example 1-1, an electrode 4 shown in FIG. 2 was produced in the following procedure.

First, hydroxypropyl methylcellulose was dissolved in N-methylpyrrolidone (NMP). Next, carbon black as a conductive agent was added to NMP in which hydroxypropyl methylcellulose was dissolved. Thereafter, carbon black was sufficiently dispersed. Thereafter, titanium dioxide TiO₂(B) was added to the dispersion liquid. Thereafter, polyvinylidene fluoride (PVDF) as a binder was added to the dispersion liquid, followed by mixing. The average molecular weight of the used PVDF was 4×10⁵.

Thus, there was prepared an electrode-producing slurry containing hydroxypropyl methylcellulose, carbon black, TiO₂(B), and PVDF. The mass ratio of hydroxypropyl methylcellulose:carbon black:TiO₂(B):PVDF was 9:10:80:1.

The obtained slurry was applied to an aluminum foil having a thickness of 15 μm as a current collector 4a, and dried, to obtain a film. The film was pressed. The pressing was performed while a press pressure was adjusted such that the density of the film was 2.2 g/cm³. Thus, there was obtained an electrode 4 including the current collector 4a and an active substance layer 4b formed thereon.

The active substance layer 4b of the obtained electrode 4 was observed by cross-sectional SEM, and it was confirmed that the active substance layer 4b included an active substance 40 having the same structure as that of the active substance 40 shown in FIG. 1. More specifically, the active substance 40 included in the active substance layer 4b included a plurality of composites 41 and a binding phase 45 positioned between these composites 41. Each of the composites 41 included an active material particle 42 as TiO₂(B), and a coating layer 43 coating the entire surface of the active material particle 42. The coating layer 43 included hydroxypropyl methylcellulose. The coating layer 43 further included carbon black 44 as a conductive agent. The binding phase 45 positioned between the composites 41 included PVDF.

### Examples 1-2 to 1-9

In each of examples 1-2 to 1-9, an electrode 4 was produced in the same manner as in example 1-1 except that the ratio by mass % of hydroxypropyl methylcellulose:PVDF in an electrode-producing slurry was changed as shown in Table 1.

An active substance layer 4b of the electrode 4 obtained in each of examples was observed by cross-sectional SEM, and it was confirmed that the active substance layer 4b included an active substance 40 having the same structure as that of the battery active substance 40 shown in FIG. 1 as in example 1-1.

### Comparative Example 1-1

In comparative example 1-1, an electrode was produced in the same manner as in example 1-1 except that an electrode-producing slurry was prepared without using PVDF. The ratio by mass % of hydroxypropyl methylcellulose:carbon black:TiO₂(B) in the electrode-producing slurry prepared in comparative example 1-1 was 10:10:80.

### Comparative Example 1-2

In comparative example 1-2, an electrode was produced in the same manner as in example 1-1 except that an electrode-producing slurry was prepared without using hydroxypropyl methylcellulose. The ratio by mass % of carbon black:TiO₂(B):PVDF in the prepared electrode-producing slurry was 10:80:10.

### Comparative Example 1-3

In comparative example 1-3, an electrode was produced in the same manner as in example 1-5 except that PVDF was added to NMP together with hydroxypropyl methylcellulose when an electrode-producing slurry was prepared.

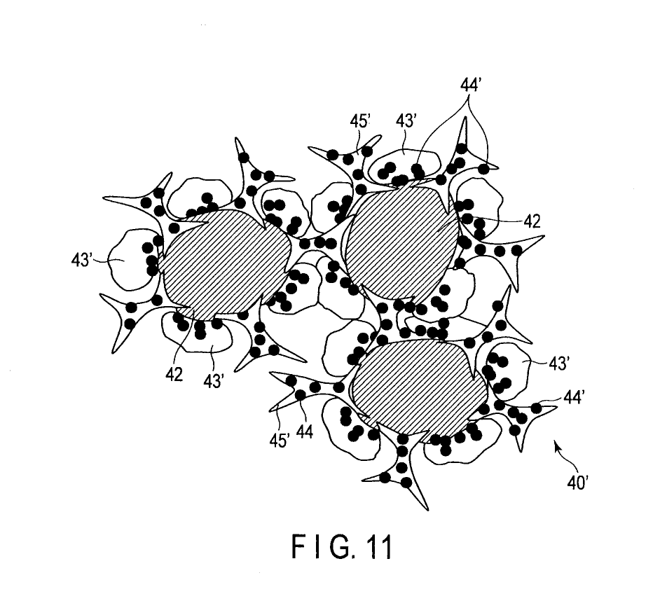

An active substance layer of the electrode obtained in comparative example 1-3 was observed by cross-sectional SEM, and it was confirmed that the active substance layer included an active substance 40′ as shown in FIG. 11. The active substance 40′ included a plurality of active material particles 42 as TiO₂ as shown in FIG. 11. A hydroxypropyl methylcellulose phase 43′ and a polyvinylidene fluoride phase 45′ were positioned on the surfaces of the active material particles 42. Carbon black 44 was dispersed in the hydroxypropyl methylcellulose phase 43′ and in the polyvinylidene fluoride phase 45′. Herein, the carbon black 44 was uniformly dispersed in the hydroxypropyl methylcellulose phase 43′. However, the carbon black 44 was not uniformly dispersed in the polyvinylidene fluoride phase 45′. The polyvinylidene fluoride phase 45′ bound the two or more active material particles 42.

### Examples 2-1 to 2-9

In each of examples 2-1 to 2-9, an electrode 4 was produced in the same manner as in each of examples 1-1 to 1-9 except that lithium titanate Li₄Ti₅O₁₂ (hereinafter, referred to as LTO) was used in place of TiO₂(B).

The ratio by mass % of hydroxypropyl methylcellulose:PVDF in an electrode-producing slurry prepared in each of examples 2-1 to 2-9 is shown in the following Table 2.

An active substance layer 4b of the electrode 4 obtained in each of examples was observed by cross-sectional SEM, and it was confirmed that the active substance layer 4b included an active substance 40 having the same structure as that of the battery active substance 40 shown in FIG. 1 as in example 1-1.

### Comparative Examples 2-1 to 2-3

In each of comparative examples 2-1 to 2-3, an electrode was produced in the same manner as in each of comparative examples 1-1 to 1-3 except that LTO was used in place of TiO₂(B).

### Examples 3-1 to 3-9

In each of examples 3-1 to 3-9, an electrode 4 was produced in the same manner as in each of examples 1-1 to 1-9 except that LTO was added to NMP together with TiO₂(B) when an electrode-producing slurry was prepared.

In each of examples 3-1 to 3-9, the ratio by mass of TiO₂(B):LTO in the prepared electrode-producing slurry was set to 40:40.

The ratio by mass % of hydroxypropyl methylcellulose : PVDF in the electrode-producing slurry prepared in each of examples 3-1 to 3-9 is shown in the following Table 3.

An active substance layer 4b of the electrode 4 obtained in each of examples was observed by cross-sectional SEM, and it was confirmed that the active substance layer 4b included an active substance 40 having the same structure as that of the battery active substance 40 shown in FIG. 1 as in example 1-1.

### Comparative Examples 3-1 to 3-3

In each of comparative examples 3-1 to 3-3, an electrode was produced in the same manner as in each of comparative examples 1-1 to 1-3 except that LTO was added to NMP together with TiO₂(B) when an electrode-producing slurry was prepared.

In each of comparative examples 3-1 to 3-3, the ratio by mass % of TiO₂(B):LTO in the prepared electrode-producing slurry was set to 40:40.

### Examples 4-1 to 4-9

In each of examples 4-1 to 4-9, an electrode 4 was produced in the same manner as in each of examples 1-1 to 1-9 except that niobium titanate Nb₂TiO₇ (hereinafter, referred to as NTO) was used in place of TiO₂(B).

The ratio by mass % of hydroxypropyl methylcellulose:PVDF in the electrode-producing slurry prepared in each of examples 4-1 to 4-9 is shown in the following Table 4.

An active substance layer 4b of the electrode 4 obtained in each of examples was observed by cross-sectional SEM, it was confirmed that the active substance layer 4b included an active substance 40 having the same structure as that of the battery active substance 40 shown in FIG. 1 as in example 1-1.

### Comparative Examples 4-1 to 4-3

In each of comparative examples 4-1 to 4-3, an electrode was produced in the same manner as in each of comparative examples 1-1 to 1-3 except that NTO was used in place of TiO₂(B).

### Examples 5-1 to 5-9

In each of examples 5-1 to 5-9, an electrode 4 was produced in the same manner as in each of examples 4-1 to 4-9 except that LTO was added to NMP together with NTO when an electrode-producing slurry was prepared.

In each of examples 5-1 to 5-9, the ratio by mass % of LTO:NTO in the prepared electrode-producing slurry was set to 40:40.

The ratio by mass % of hydroxypropyl methylcellulose : PVDF in the electrode-producing slurry prepared in each of examples 5-1 to 5-9 is shown in the following Table 5.

An active substance layer 4b of the electrode 4 obtained in each of examples was observed by cross-sectional SEM, and it was confirmed that the active substance layer 4b included an active substance 40 having the same structure as that of the battery active substance 40 shown in FIG. 1 as in example 1-1.

### Comparative Examples 5-1 to 5-3

In each of comparative examples 5-1 to 5-3, an electrode was produced in the same manner as in each of comparative examples 4-1 to 4-3 except that LTO was added to NMP together with NTO when an electrode-producing slurry was prepared.

In each of comparative examples 5-1 to 5-3, the ratio by mass % of LTO:NTO in the prepared electrode-producing slurry was set to 40:40.

### Example 6-1

In example 6-1, an electrode 4 shown in FIG. 2 was produced in the following procedure.

First, carboxymethyl cellulose was dissolved in pure water. Next, carbon black as a conductive agent was added to the pure water in which carboxymethyl cellulose was dissolved. Thereafter, carbon black was sufficiently dispersed. Thereafter, titanium dioxide TiO₂(B) was added to the dispersion liquid. Thereafter, styrene-butadiene rubber (SBR) as a binder was added to the dispersion liquid, followed by mixing. The average molecular weight of the used SBR was 1×10⁶.

Thus, there was prepared an electrode-producing slurry including carboxymethyl cellulose, carbon black, TiO₂(B), and SBR. The mass ratio of carboxymethyl cellulose :carbon black:TiO₂(B):SBR was 9:10:80:1.

The obtained slurry was applied to an aluminum foil having a thickness of 15 μm as a current collector 4a, and dried, to obtain a film. The film was pressed. The pressing was performed while a press pressure was adjusted such that the density of the film was 2.2 g/cm³. Thus, there was obtained an electrode 4 including the current collector 4a and an active substance layer 4b formed thereon.

The active substance layer 4b of the obtained electrode 4 was observed by cross-sectional SEM, and it was confirmed that the active substance layer 4b included an active substance 40 having the same structure as that of the active substance 40 shown in FIG. 1. More specifically, the active substance 40 included in the active substance layer 4b included a plurality of composites 41 and a binding phase 45 positioned between these composites 41. Each of the composites 41 included an active material particle 42 as TiO₂(B), and a coating layer 43 coating the entire surface of the active material particle 42. The coating layer 43 included carboxymethyl cellulose. The coating layer 43 further included carbon black 44 as a conductive agent. The binding phase 45 positioned between the composites 41 included SBR.

### Examples 6-2 to 6-9

In each of examples 6-2 to 6-9, an electrode 4 was produced in the same manner as in example 6-1 except that the ratio by mass % of carboxymethyl cellulose:SBR in an electrode-producing slurry was changed as shown in Table 6.

An active substance layer 4b of the electrode 4 obtained in each of examples was observed by cross-sectional SEM, and it was confirmed that the active substance layer 4b included an active substance 40 having the same structure as that of the battery active substance 40 shown in FIG. 1 as in example 6-1.

### Comparative Example 6-1

In comparative example 6-1, an electrode was produced in the same manner as in example 6-1 except that an electrode-producing slurry was prepared without using SBR. The ratio by mass % of carboxymethyl cellulose:carbon black:TiO₂(B) in an electrode-producing slurry prepared in comparative example 6-1 was 10:10:80.

### Comparative Example 6-2

In comparative example 6-2, an electrode was produced in the same manner as in example 6-1 except that an electrode-producing slurry was prepared without using carboxymethyl cellulose. The ratio by mass % of carbon black:TiO₂(B):SBR in the prepared electrode-producing slurry was 10:80:10.

### Comparative Example 6-3

In comparative example 6-3, an electrode was produced in the same manner as in example 6-5 except that SBR was added to pure water together with carboxymethyl cellulose when an electrode-producing slurry was prepared.

An active substance layer of the electrode obtained in comparative example 6-3 was observed by cross-sectional SEM, and it was confirmed that the active substance layer included an active substance having the same structure as that of the active substance 40′ as shown in FIG. 11. The active substance included a plurality of active material particles as TiO₂. A carboxymethyl cellulose phase and a styrene-butadiene rubber phase were positioned on the surfaces of the active material particles. Carbon black was dispersed in the carboxymethylcellulose phase and in the styrene-butadiene rubber phase. Herein, carbon black was uniformly dispersed in the carboxymethyl cellulose phase. However, carbon black was not uniformly dispersed in the styrene-butadiene rubber phase. The styrene-butadiene rubber phase bound the two or more active material particles.

### Examples 7-1 to 7-9

In each of examples 7-1 to 7-9, an electrode 4 was produced in the same manner as in each of examples 6-1 to 6-9 except that lithium titanate Li₄Ti₅O₁₂ (hereinafter, referred to as LTO) was used in place of TiO₂(B).

The ratio by mass % of carboxymethyl cellulose:SBR in an electrode-producing slurry prepared in each of examples 7-1 to 7-9 is shown in the following Table 7.

An active substance layer 4b of the electrode 4 obtained in each of examples was observed by cross-sectional SEM, and it was confirmed that the active substance layer 4b included an active substance 40 having the same structure as that of the active substance 40 shown in FIG. 1 as in example 6-1.

### Comparative Examples 7-1 to 7-3

In each of examples 7-1 to 7-3, an electrode was produced in the same manner as in each of comparative examples 6-1 to 6-3 except that LTO was used in place of TiO₂(B).

### Examples 8-1 to 8-9

In examples 8-1 to 8-9, an electrode 4 was produced in the same manner as in each of examples 6-1 to 6-9 except that LTO was added to pure water together with TiO₂(B) when an electrode-producing slurry was prepared.

In each of examples 8-1 to 8-9, the ratio by mass % of TiO₂(B):LTO in the prepared electrode-producing slurry was set to 40:40.

The ratio by mass % of carboxymethyl cellulose:SBR in the electrode-producing slurry prepared in each of examples 8-1 to 8-9 is shown in the following Table 8.

An active substance layer 4b of the electrode 4 obtained in each of examples was observed by cross-sectional SEM, and it was confirmed that the active substance layer 4b included an active substance 40 having the same structure as that of the active substance 40 shown in FIG. 1 as in example 6-1.

### Comparative Examples 8-1 to 8-3

In each of comparative examples 8-1 to 8-3, an electrode was produced in the same manner as in each of comparative examples 6-1 to 6-3 except that LTO was added to pure water together with TiO₂(B) when an electrode-producing slurry was prepared.

In each of comparative examples 8-1 to 8-3, the ratio by mass % of TiO₂(B):LTO in the prepared electrode-producing slurry was set to 40:40.

### Examples 9-1 to 9-9

In each of examples 9-1 to 9-9, an electrode 4 was produced in the same manner as in each of examples 6-1 to 6-9 except that niobium titanate Nb₂TiO₇ (hereinafter, referred to as NTO) was used in place of TiO₂(B).

The ratio by mass % of carboxymethyl cellulose:SBR in the electrode-producing slurry prepared in each of examples 9-1 to 9-9 is shown in the following Table 9.

An active substance layer 4b of the electrode 4 obtained in each of examples was observed by cross-sectional SEM, and it was confirmed that the active substance layer 4b included an active substance 40 having the same structure as that of the active substance 40 shown in FIG. 1 as in example 6-1.

### Comparative Examples 9-1 to 9-3

In each of comparative examples 9-1 to 9-3, an electrode was produced in the same manner as in each of comparative examples 6-1 to 6-3 except that NTO was used in place of TiO₂(B).

### Examples 10-1 to 10-9

In each of examples 10-1 to 10-9, an electrode 4 was produced in the same manner as in each of examples 9-1 to 9-9 except that LTO was added to pure water together with NTO when an electrode-producing slurry was prepared.

In each of examples 10-1 to 10-9, the ratio by mass % of LTO:NTO in the prepared electrode-producing slurry was set to 40:40.

The ratio by mass % of carboxymethyl cellulose:SBR in the electrode-producing slurry prepared in each of examples 10-1 to 10-9 is shown in the following Table 10.

An active substance layer 4b of the electrode 4 obtained in each of examples was observed by cross-sectional SEM, and it was confirmed that the active substance layer 4b included an active substance 40 having the same structure as that of the active substance 40 shown in FIG. 1 as in example 6-1.

### Comparative Examples 10-1 to 10-3

In each of comparative examples 10-1 to 10-3, an electrode was produced in the same manner as in each of comparative examples 9-1 to 9-3 except that LTO was added to pure water together with NTO when an electrode-producing slurry was prepared.

In each of comparative examples 10-1 to 10-3, the ratio by mass % of LTO:NTO in the prepared electrode-producing slurry was set to 40:40.

<Production of Evaluation Cell>

An evaluation cell was produced in the following procedure using each of the electrodes 4 produced as described above.

First, the electrode 4 produced above was cut into a square with sides of 2 cm long. This cut electrode was used as a working electrode. A lithium metal foil which was a square with sides of 2.0 cm long was prepared and used as a counter electrode. A lithium metal was prepared and used as a reference electrode. The working electrode and the counter electrode were opposed to each other with a glass filter as a separator interposed therebetween. The working electrode and the counter electrode which were opposed to each other, and the reference electrode were placed in a three-pole type glass cell. In this case, the reference electrode was inserted in such a manner that it was not brought into contact with the working electrode and the counter electrode. Next, each of the working electrode, the counter electrode, and the reference electrode was connected to a corresponding terminal of the glass cell. On the other hand, an electrolyte solution was prepared by dissolving LiPF₆ as an electrolyte in a mixture solvent. The used mixture solvent included ethylene carbonate and diethyl carbonate in a ratio by volume of 1:2. The concentration of LiPF₆ was 1 mol/L. Twenty-five mL of this electrolyte solution was poured into the glass cell. After the separator and the electrodes were sufficiently impregnated with the electrolyte solution, the glass cell was sealed. Thus, evaluation cells according to examples and comparative examples were produced.

(Charge-and-Discharge Test)

Using each of the evaluation cells produced above, a charge-and-discharge test was performed in a 25° C. thermostatic chamber. The charge-and-discharge rate was set to 1.0 C. One charging-and-discharging was performed as one cycle and 50 cycles were performed. The capacity of the cell was measured after the first charging-and-discharging and after 50 cycles. A capacity at 0.2 C was confirmed at the 25th cycle and 50th cycle. The first discharge capacity was set to 100% to calculate the discharge capacity retention (%) after 50 cycles. The results of the capacity retentions of examples and comparative examples are shown in Tables 1 to 10.

The resistance value (Ω) after 50 cycles was measured. The resistance value was measured in the following manner. The evaluation cell was set to an AC impedance measuring device to measure impedance while sweeping the frequency from 300 MHz to 10 Hz. A cole-cole plot of the obtained data was made to determine the maximum point of intersection of the plotted curve and X-axis as the resistance value. The results of the resistance values of examples and comparative examples after 50 cycles are shown in the following Tables 1 to 10.

<Measurement of Peel Strength>

In each of examples and comparative examples, the peel strength (g/cm) of the electrode prepared by applying the electrode-producing slurry to aluminum, followed by drying, i.e., the electrode before being pressed was measured.

The peel strength was measured in the following manner. First, each electrode obtained by applying an electrode-producing slurry to aluminum, followed by drying was cut into a 2×5 cm strip form, and was used as a measurement sample. Next, a tape was applied to the surface of an active substance layer of each measurement sample, and was subjected to a tensile-strength tester to peel the active substance layer from a current collector. The force required when the active substance layer in the sample of each of examples and comparative examples was peeled off was recorded as the peel strength. The results are shown in the following Tables 1 to 10.

TABLE 1
Series of Example 1 (Active Material: TiO₂ (B))

| | Ratio by mass % of | | Capacity | Resistance |
|---|---|---|---|---|
| | Hydroxypropyl | | retention | value (Ω) |
| | Methylcellulose: | Peel | (%) after 50 | after 50 |
| | PVDF in | Strength | cycles at | cycles at |
| | Electrode- | (g/cm) of | high | high |
| | Producing slurry | Electrode | temperature | temperature |
| Comparative | 10:0 | 5 | 20 | 29 |
| Example 1-1 | | | | |
| Example 1-1 | 9:1 | 15 | 33 | 22 |
| Example 1-2 | 8:2 | 18 | 43 | 20 |
| Example 1-3 | 7:3 | 21 | 57 | 19 |
| Example 1-4 | 6:4 | 21 | 56 | 18 |
| Example 1-5 | 5:5 | 20 | 51 | 19 |
| Example 1-6 | 4:6 | 18 | 49 | 21 |
| Example 1-7 | 3:7 | 15 | 47 | 23 |
| Example 1-8 | 2:8 | 13 | 41 | 27 |
| Example 1-9 | 1:9 | 11 | 34 | 34 |
| Comparative | 0:10 | 8 | 13 | 84 |
| Example 1-2 | | | | |
| Comparative | 5:5 | 24 | 55 | 40 |
| Example 1-3 | | | | |

TABLE 2
Series of Example 2 (Active Material: LTO)

| | Ratio by mass % of | | Capacity | Resistance |
|---|---|---|---|---|
| | Hydroxypropyl | | retention | value (Ω) |
| | Methylcellulose: | Peel | (%) after | after 50 |
| | PVDF in | Strength | 50 cycles | cycles at |
| | Electrode- | (g/cm) of | at high | high |
| | Producing slurry | Electrode | temperature | temperature |
| Comparative | 10:0 | 7 | 25 | 20 |
| Example 2-1 | | | | |
| Example 2-1 | 9:1 | 21 | 42 | 14 |
| Example 2-2 | 8:2 | 25 | 53 | 12 |
| Example 2-3 | 7:3 | 29 | 75 | 10 |
| Example 2-4 | 6:4 | 29 | 77 | 9 |
| Example 2-5 | 5:5 | 28 | 67 | 11 |
| Example 2-6 | 4:6 | 25 | 56 | 12 |
| Example 2-7 | 3:7 | 21 | 55 | 12 |
| Example 2-8 | 2:8 | 18 | 49 | 13 |
| Example 2-9 | 1:9 | 15 | 47 | 13 |
| Comparative | 0:10 | 10 | 35 | 18 |
| Example 2-2 | | | | |
| Comparative | 5:5 | 80 | 71 | 17 |
| Example 2-3 | | | | |

TABLE 3
Series of Example 3 (Active Material: TiO₂ (B) + LTO)

| | Ratio by mass % of | | Capacity | Resistance |
|---|---|---|---|---|
| | Hydroxypropyl | | retention | value (Ω) |
| | Methylcellulose: | Peel | (%) after | after 50 |
| | PVDF in | Strength | 50 cycles | cycles at |
| | Electrode- | (g/cm) of | at high | high |
| | Producing slurry | Electrode | temperature | temperature |
| Comparative | 10:0 | 7 | 24 | 27 |
| Example 3-1 | | | | |
| Example 3-1 | 9:1 | 19 | 39 | 21 |
| Example 3-2 | 8:2 | 24 | 48 | 17 |
| Example 3-3 | 7:3 | 26 | 66 | 16 |
| Example 3-4 | 6:4 | 27 | 68 | 14 |
| Example 3-5 | 5:5 | 26 | 60 | 15 |
| Example 3-6 | 4:6 | 24 | 52 | 19 |
| Example 3-7 | 3:7 | 19 | 50 | 20 |
| Example 3-8 | 2:8 | 16 | 43 | 24 |
| Example 3-9 | 1:9 | 12 | 36 | 30 |
| Comparative | 0:10 | 11 | 30 | 37 |
| Example 3-2 | | | | |
| Comparative | 5:5 | 31 | 59 | 29 |
| Example 3-3 | | | | |

TABLE 4
Series of Example 4 (Active material: NTO)

| | Ratio by mass % of | | Capacity | Resistance |
|---|---|---|---|---|
| | Hydroxypropyl | | retention | value (Ω) |
| | Methylcellulose: | Peel | (%) after | after 50 |
| | PVDF in | Strength | 50 cycles | cycles at |
| | Electrode- | (g/cm) of | at high | high |
| | Producing slurry | Electrode | temperature | temperature |
| Comparative | 10:0 | 3 | 15 | 44 |
| Example 4-1 | | | | |
| Example 4-1 | 9:1 | 12 | 25 | 35 |
| Example 4-2 | 8:2 | 14 | 33 | 33 |
| Example 4-3 | 7:3 | 17 | 45 | 31 |
| Example 4-4 | 6:4 | 17 | 40 | 30 |
| Example 4-5 | 5:5 | 14 | 39 | 32 |
| Example 4-6 | 4:6 | 13 | 37 | 34 |
| Example 4-7 | 3:7 | 10 | 35 | 38 |
| Example 4-8 | 2:8 | 7 | 32 | 41 |
| Example 4-9 | 1:9 | 4 | 27 | 42 |
| Comparative | 0:10 | 2 | 12 | 57 |
| Example 4-2 | | | | |
| Comparative | 5:5 | 16 | 39 | 45 |
| Example 4-3 | | | | |

TABLE 5
Series of Example 5 (Active Material: LTO + NTO)

| | Ratio by mass % of | | Capacity | Resistance |
|---|---|---|---|---|
| | Hydroxypropyl | | retention | value (Ω) |
| | Methylcellulose: | Peel | (%) after | after 50 |
| | PVDF in | Strength | 50 cycles | cycles at |
| | Electrode- | (g/cm) of | at high | high |
| | Producing slurry | Electrode | temperature | temperature |
| Comparative | 10:0 | 4 | 19 | 35 |
| Example 5-1 | | | | |
| Example 5-1 | 9:1 | 16 | 30 | 30 |
| Example 5-2 | 8:2 | 19 | 41 | 26 |
| Example 5-3 | 7:3 | 23 | 54 | 24 |
| Example 5-4 | 6:4 | 23 | 50 | 24 |
| Example 5-5 | 5:5 | 20 | 46 | 25 |
| Example 5-6 | 4:6 | 17 | 40 | 27 |
| Example 5-7 | 3:7 | 15 | 39 | 29 |
| Example 5-8 | 2:8 | 11 | 38 | 33 |
| Example 5-9 | 1:9 | 7 | 35 | 37 |
| Comparative | 0:10 | 5 | 29 | 42 |
| Example 5-2 | | | | |
| Comparative | 5:5 | 23 | 47 | 38 |
| Example 5-3 | | | | |

TABLE 6
Series of Example 6 (Active Material: TiO₂ (B))

| | Ratio by mass | | | |
|---|---|---|---|---|
| | % of | | Capacity | Resistance |
| | Carboxymethyl | | retention | value (Ω) |
| | Cellulose:SBR | Peel | (%) after 50 | after 50 |
| | in Electrode- | Strength | cycles at | cycles at |
| | producing | (g/cm) of | high | high |
| | slurry | Electrode | temperature | temperature |
| Comparative | 10:0 | 6 | 21 | 33 |
| Example 6-1 | | | | |
| Example 6-1 | 9:1 | 16 | 35 | 24 |
| Example 6-2 | 8:2 | 20 | 47 | 26 |
| Example 6-3 | 7:3 | 27 | 63 | 25 |
| Example 6-4 | 6:4 | 22 | 66 | 20 |
| Example 6-5 | 5:5 | 22 | 56 | 23 |
| Example 6-6 | 4:6 | 17 | 52 | 26 |
| Example 6-7 | 3:7 | 17 | 50 | 27 |
| Example 6-8 | 2:8 | 15 | 47 | 30 |
| Example 6-9 | 1:9 | 13 | 33 | 37 |
| Comparative | 0:10 | 10 | 15 | 88 |
| Example 6-2 | | | | |
| Comparative | 5:5 | 33 | 64 | 46 |
| Example 6-3 | | | | |

TABLE 7
Series of Example 7 (Active Material: LTO)

| | Ratio by mass | | | |
|---|---|---|---|---|
| | % of | | Capacity | Resistance |
| | Carboxymethyl | | retention | value (Ω) |
| | Cellulose:SBR | Peel | (%) after | after 50 |
| | in Electrode- | Strength | 50 cycles | cycles at |
| | producing | (g/cm) of | at high | high |
| | slurry | Electrode | temperature | temperature |
| Comparative | 10:0 | 9 | 24 | 28 |
| Example 7-1 | | | | |
| Example 7-1 | 9:1 | 27 | 47 | 20 |
| Example 7-2 | 8:2 | 32 | 53 | 18 |
| Example 7-3 | 7:3 | 32 | 75 | 17 |
| Example 7-4 | 6:4 | 29 | 79 | 11 |
| Example 7-5 | 5:5 | 32 | 73 | 12 |
| Example 7-6 | 4:6 | 27 | 63 | 13 |
| Example 7-7 | 3:7 | 25 | 54 | 12 |
| Example 7-8 | 2:8 | 27 | 53 | 14 |
| Example 7-9 | 1:9 | 17 | 49 | 16 |
| Comparative | 0:10 | 11 | 41 | 26 |
| Example 7-2 | | | | |
| Comparative | 5:5 | 87 | 75 | 26 |
| Example 7-3 | | | | |

TABLE 8
Series of Example 8 (Active Material: TiO₂ (B) + LTO)

| | Ratio by mass | | | |
|---|---|---|---|---|
| | % of | | | |
| | Carboxymethyl | | Capacity | Resistance |
| | Cellulose: | | retention | value (Ω) |
| | SBR in | Peel | (%) after | after 50 |
| | Electrode- | Strength | 50 cycles | cycles at |
| | producing | (g/cm) of | at high | high |
| | slurry | Electrode | temperature | temperature |
| Comparative | 10:0 | 12 | 27 | 32 |
| Example 8-1 | | | | |
| Example 8-1 | 9:1 | 20 | 41 | 29 |
| Example 8-2 | 8:2 | 24 | 56 | 26 |
| Example 8-3 | 7:3 | 27 | 65 | 17 |
| Example 8-4 | 6:4 | 35 | 70 | 13 |
| Example 8-5 | 5:5 | 27 | 62 | 21 |
| Example 8-6 | 4:6 | 26 | 58 | 22 |
| Example 8-7 | 3:7 | 24 | 55 | 22 |
| Example 8-8 | 2:8 | 22 | 49 | 24 |
| Example 8-9 | 1:9 | 14 | 38 | 38 |
| Comparative | 0:10 | 19 | 32 | 45 |
| Example 8-2 | | | | |
| Comparative | 5:5 | 31 | 59 | 37 |
| Example 8-3 | | | | |

TABLE 9
Series of Example 9 (Active Material: NTO)

| | Ratio by mass | | | |
|---|---|---|---|---|
| | % of | | Capacity | Resistance |
| | Carboxymethyl | | retention | value (Ω) |
| | Cellulose:SBR | Peel | (%) after | after 50 |
| | in Electrode- | Strength | 50 cycles | cycles at |
| | producing | (g/cm) of | at high | high |
| | slurry | Electrode | temperature | temperature |
| Comparative | 10:0 | 8 | 23 | 43 |
| Example 9-1 | | | | |
| Example 9-1 | 9:1 | 13 | 31 | 38 |
| Example 9-2 | 8:2 | 15 | 38 | 35 |
| Example 9-3 | 7:3 | 23 | 46 | 35 |
| Example 9-4 | 6:4 | 24 | 44 | 37 |
| Example 9-5 | 5:5 | 20 | 42 | 40 |
| Example 9-6 | 4:6 | 15 | 41 | 40 |
| Example 9-7 | 3:7 | 14 | 41 | 42 |
| Example 9-8 | 2:8 | 16 | 38 | 45 |
| Example 9-9 | 1:9 | 11 | 27 | 46 |
| Comparative | 0:10 | 10 | 18 | 64 |
| Example 9-2 | | | | |
| Comparative | 5:5 | 17 | 38 | 52 |
| Example 9-3 | | | | |

TABLE 10
Series of Example 10 (Active Material: LTO + NTO)

| | Ratio by | | | |
|---|---|---|---|---|
| | mass % of | | | |
| | Carboxymethyl | | Capacity | Resistance |
| | Cellulose: | | retention | value (Ω) |
| | SBR in | Peel | (%) after | after 50 |
| | Electrode- | Strength | 50 cycles | cycles at |
| | producing | (g/cm) of | at high | high |
| | slurry | Electrode | temperature | temperature |
| Comparative | 10:0 | 3 | 26 | 38 |
| Example 9-1 | | | | |
| Example 9-1 | 9:1 | 17 | 35 | 37 |
| Example 9-2 | 8:2 | 21 | 42 | 33 |
| Example 9-3 | 7:3 | 24 | 44 | 31 |
| Example 9-4 | 6:4 | 31 | 54 | 24 |
| Example 9-5 | 5:5 | 24 | 52 | 31 |
| Example 9-6 | 4:6 | 20 | 44 | 33 |
| Example 9-7 | 3:7 | 15 | 43 | 37 |
| Example 9-8 | 2:8 | 14 | 43 | 38 |
| Example 9-9 | 1:9 | 11 | 35 | 40 |
| Comparative | 0:10 | 8 | 34 | 45 |
| Example 9-2 | | | | |
| Comparative | 5:5 | 23 | 54 | 41 |
| Example 9-3 | | | | |

The results shown in Table 1 show that the electrodes 4 of examples 1-1 to 1-9 can exhibit excellent peel strength and an excellent capacity retention, and can exhibit a low resistance value. The reason behind the results will be described below.

As described earlier, the active substances 40 included in the electrodes 4 of examples 1-1 to 1-9 had the same structure as that of the active substance 40 shown in FIG. 1.

In the electrodes 4 of examples 1-1 to 1-9 in which the active substance 40 had such a structure, the entire surface of the active material particle 42 was coated with the coating layer 43 including hydroxypropyl methylcellulose. Because of this, the reaction between the active material particle 42 and the nonaqueous electrolyte and the reaction between the active material particle 42 and the binding phase 45 could be suppressed. As a result, deterioration of electrode performance, an increase in internal resistance of a battery, deterioration of a nonaqueous electrolyte, and deterioration of adhesive property of the active substance layer 4b to the current collector 4a could be prevented. The binding phase 45 positioned between the composites 41 including the active material particle 42 and the coating layer 43 could suppress the swelling of the coating layer 43 caused by absorbing the nonaqueous electrolyte. Therefore, the above-mentioned effect exhibited by the existence of the coating layer 43 could be maintained even after 50 cycles. Furthermore, the binding phase 45 included polyvinylidene fluoride capable of exhibiting excellent binding ability. Therefore, the binding phase 45 could exhibit excellent binding ability between the composites 41, and excellent adhesive ability of the active substance layer 4b to the current collector 4a. Further, because the coating layer 43 could suppress the reaction between the binding phase 45 and the active material particle 42, the binding ability of the binding phase 45 could be maintained.

As a result, the electrodes 4 of examples 1-1 to 1-9 could exhibit excellent peel strength, an excellent capacity retention, and a low resistance value.

On the other hand, as shown in Table 1, the electrode of comparative example 1-1 exhibited poorer peel strength and capacity retention than those of the electrodes of examples 1-1 to 1-9. The reason for this is considered to be that the binding phase positioned between the plurality of composites including the active material particle and the coating layer coating the active material particle is not present in comparative example 1-1, which leads to poor connectivity between the composites and poor adhesive ability of the active substance layer to the current collector.

As shown in Table 1, the electrode of comparative example 1-2 had poorer peel strength, capacity retention, and resistance value than those of the electrodes of examples 1-1 to 1-9. The reason for this will be considered as described below. The active material particles as TiO₂(B) were not coated with the coating layer in the electrode of comparative example 1-2, which led to the contact of the active material particles with the polyvinylidene fluoride as the binder. This contact caused decomposition of polyvinylidene fluoride, which caused deterioration of the binding ability of polyvinylidene fluoride, or the like. The electrode of comparative example 1-2 actively caused the active material particles to react with the nonaqueous electrolyte as compared with the electrodes of examples 1-1 to 1-9, which formed a byproduct. As a result, deterioration of electrode performance, an increase in internal resistance of a battery, deterioration of a nonaqueous electrolyte or the like are assumed to be caused.

As shown in Table 1, the electrode of comparative example 1-3 exhibited peel strength and a capacity retention comparable to those of the electrode of example 1-5, and a high resistance value. In the electrode of comparative example 1-3, as described with reference to FIG. 11, the polyvinylidene fluoride phase 45′ was bound to the surfaces of the active material particles 42. Because the polyvinylidene fluoride phase 45′ had low electrolyte permeability, the polyvinylidene fluoride phase 45′ had low functionality as a lithium ion path. Therefore, the release and adsorption of lithium ions in the active material particles 42 are considered to be hindered in the electrode of comparative example 1-3. Furthermore, as described earlier with reference to FIG. 11, the polyvinylidene fluoride phase 45′ is considered to only provide a low dispersing ability of the carbon black 44.

Therefore, in the electrode of comparative example 1-3, the active substance layer is considered to have low electrical conductivity. As a result of such, the electrode of comparative example 1-3 is considered to exhibit a high resistance value.

The results of examples 2-1 to 2-9 and comparative examples 2-1 to 2-3 shown in Table 2, the results of examples 3-1 to 3-9 and comparative examples 3-1 to 3-3 shown in Table 3, the results of examples 4-1 to 4-9 and comparative examples 4-1 to 4-3 shown in Table 4, and the results of examples 5-1 to 5-9 and comparative examples 5-1 to 5-3 shown in Table 5 showed the same tendency as those the results of examples 1-1 to 1-9 and comparative examples 1-1 to 1-3 shown in Table 1. This shows that all examples have the same effect regardless of the kind of the active material particles 42.

Also, the results shown in Tables 1 to 5 showed that an electrode having higher strength was obtained when the active substance 41 including hydroxypropyl methylcellulose and PVDF and including hydroxypropyl methylcellulose in a ratio of 10% by mass or more was used.

Furthermore, the results of examples 6-1 to 6-9 and comparative examples 6-1 to 6-3 shown in Table 6, the results of examples 7-1 to 7-9 and comparative examples 7-1 to 7-3 shown in Table 7, the results of examples 8-1 to 8-9 and comparative examples 8-1 to 8-3 shown in Table 8, the results of example 9-1 to 9-9 and comparative examples 9-1 to 9-3 shown in Table 9, and the results of examples 10-1 to 10-9 and comparative examples 10-1 to 10-3 shown in Table 10 showed the same tendency as those of the results of examples 1-1 to 1-9 and comparative examples 1-1 and 1-3 shown in Table 1, the results of examples 2-1 to 2-9 and comparative example 2-1 and 2-3 shown in Table 2, the results of examples 3-1 to 3-9 and comparative examples 3-1 and 3-3 shown in Table 3, the results of examples 4-1 to 4-9 and comparative examples 4-1 to 4-3 shown in Table 4, and the results of examples 5-1 to 5-9 and comparative examples 5-1 to 5-3 shown in Table 5, respectively. This shows that the example using carboxymethyl cellulose as the material of the coating layer 43 and using styrene-butadiene rubber as the material of the binding phase 45 also has the same effect as that of the example using hydroxyalkyl cellulose and polyvinylidene fluoride.

According to at least one embodiment and example mentioned above, an active substance is provided. This active substance includes a plurality of composites and a binding phase positioned between the composites. The composite includes an active material particle and a coating layer coating the active material particles. The coating layer includes at least one material selected from the group consisting of hydroxyalkyl cellulose and carboxymethyl cellulose. The binding phase includes at least one selected from the group consisting of polyvinylidene fluoride, styrene-butadiene rubber, and an acrylic-based polymer. Because the active substance can suppress the reaction between the active material particle and a nonaqueous electrolyte and the reaction between the active material particle and the binding phase in a nonaqueous electrolyte battery including the active substance, the active substance can suppress problems such as deterioration of electrode performance of the nonaqueous electrolyte battery, an increase in internal resistance, and deterioration of the nonaqueous electrolyte. As a result of such, this active substance can attain a nonaqueous electrolyte battery which can exhibit a high capacity retention after a cycle and suppress an increase in a resistance value through a cycle.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An active substance comprising:
a plurality of composites, each comprising an active material particle and a coating layer coating the active material particle, the coating layer comprising at least one material selected from the group consisting of hydroxyalkyl cellulose and carboxymethyl cellulose; and
a binding phase positioned between the composites, the binding phase comprising at least one selected from the group consisting of polyvinylidene fluoride, styrene-butadiene rubber, and an acrylic-based polymer.

2. The active substance according to claim 1, wherein the active material particle comprises at least one selected from the group consisting of lithium titanate having a spinel structure, a monoclinic β-type titanium composite oxide, a niobium titanium composite oxide, silicon, a silicon composite oxide, and graphite.

3. The active substance according to claim 1, wherein the active material particle comprises at least one selected from the group consisting of lithium titanate having a spinel structure, a monoclinic β-type titanium composite oxide, and a niobium titanium composite oxide.

4. The active substance according to claim 1, wherein the hydroxyalkyl cellulose is at least one selected from the group consisting of hydroxypropyl methylcellulose, hydroxypropyl cellulose, hydroxyethyl cellulose, and hydroxypropylethyl cellulose.

5. The active substance according to claim 1, wherein a ratio of a total mass of the at least one material to a sum of the total mass of the at least one material and a mass of the binding phase is within a range of 10% by mass to 90% by mass.

6. The active substance according to claim 1, wherein the coating layer further comprises a conductive agent.

7. An electrode comprising:
a current collector; and
an active-substance layer provided on the current collector and comprising the active substance according to claim 1.

8. A nonaqueous electrolyte battery comprising:
a positive electrode;
the electrode according to claim 7 as a negative electrode; and
a nonaqueous electrolyte.

9. A battery pack comprising at least one nonaqueous electrolyte battery,
wherein the at least one nonaqueous electrolyte battery comprises a positive electrode, the electrode according to claim 7 as a negative electrode, and a nonaqueous electrolyte.

10. The battery pack according to claim 9, comprising a plurality of nonaqueous electrolyte batteries,
wherein each of the plurality of nonaqueous electrolyte batteries comprises a positive electrode, the electrode according to claim 7 as a negative electrode, and a nonaqueous electrolyte, and
the plurality of nonaqueous electrolyte batteries are electrically connected to each other in series, in parallel or in a combination thereof.

11. The battery pack according to claim 9, further comprising a protective circuit configured to detect a voltage of the nonaqueous electrolyte battery.
